(19) United States
(12) Patent Application Publication
(10) Pub. No.: US 2016/0333187 A1
(43) Pub. Date: Nov. 17, 2016

(54) SYSTEMS AND METHODS FOR CONTROLLING THE DEGRADATION OF DEGRADABLE MATERIALS

(71) Applicants: LiquiGlide Inc., Cambridge, MA (US); DropWise Technologies Corp., Cambridge, MA (US)

(72) Inventors: Uwe Bauer, Cambridge, MA (US); Tao Cong, Quincy, MA (US); Jonathan David Smith, Cambridge, MA (US); Kripa Varanassi, Lexington, MA (US); David C. Borelli, Cambridge, MA (US); Adam T. Paxson, Cambridge, MA (US); Hyukmin Kwon, Cambridge, MA (US)

(21) Appl. No.: 15/155,642

(22) Filed: May 16, 2016

Related U.S. Application Data
(60) Provisional application No. 62/161,561, filed on May 14, 2015.
(60) Provisional application No. 62/216,215, filed on Sep. 9, 2015.

(51) Int. Cl. C09D 5/00; C09D 201/00

(52) U.S. Cl. CPC C09D 5/00; C09D 201/00

(57) ABSTRACT

Embodiments described herein relate generally to a system and methods for controlling and/or modifying the degradation behavior of degradable materials via a surface treatment and/or coating. This surface treatment and/or coating (also referred to herein as a “barrier”) can be used to modify the degradation profile without changing the bulk of the degradable material. The system includes a substrate that includes a degradable material and barrier configured to protect the substrate from a foreign environment. The barrier can include a conformal coating and/or a liquid impregnated surface engineered specifically to tailor the degradation profile of the underlying substrate. Optionally, a trigger mechanism can be used to further control and/or modify the degradation behavior of the substrate.

### CROSS-REFERENCE TO RELATED APPLICATIONS

This application claims priority to and the benefit of U.S. Provisional Patent Application Ser. No. 62/161,561, filed May 14, 2015 and titled “Systems and Methods for Controlling the Degradation of Degradable Materials,” and U.S. Provisional Patent Application Ser. No. 62/216,215, filed Sep. 9, 2015 and titled “Systems and Methods for Controlling the Degradation of Degradable Materials,” the disclosures of which are hereby incorporated by reference in their entirety.

### BACKGROUND

Degradable materials are widely used in a variety of industries ranging from oil and gas to medical. While virtually all materials degrade to some extent over time, so called “degradable materials” are specifically designed to dissolve, fragment and/or otherwise disintegrate under certain well defined conditions and within a period of time that is orders of magnitude shorter than what is typically observed for “non-degradable materials.” Such degradability is technically and economically desirable, particularly for parts which are only temporarily required to fulfill their desired function and whose removal is associated with significant complexity, time and cost. Simply using pieces and equipment that comprise in part or in its entirety of dissolvable, disintegrating or degradable materials can help alleviate or altogether eliminate the risks of leaving something behind.

Currently, it is difficult to control the degradation of degradable materials without modifying the composition and/or structure of the bulk material itself. In particular, for applications in which a degradable material is subject to a range of conditions (e.g. water with a range of salinity or pH), adjusting the bulk material for each condition would impart significant cost and manufacturing complexity.

### SUMMARY

Embodiments described herein relate generally to a system and methods for controlling and/or modifying the degradation behavior of degradable materials via a surface treatment and/or coating. This surface treatment and/or coating (also referred to herein as a “barrier”) can be used to modify the degradation profile without changing the bulk of the degradable material. The system includes a substrate that includes a degradable material and barrier configured to protect the substrate from a foreign environment. The barrier can include a conformal coating and/or a liquid impregnated surface engineered specifically to tailor the degradation profile of the underlying substrate. Optionally, a trigger mechanism can be used to further control and/or modify the degradation behavior of the substrate.

### BRIEF DESCRIPTION OF THE DRAWINGS

FIG. 1 shows a schematic block diagram of various components in a controlled degradation system, according to an embodiment.

FIG. 2A-2C show exemplary degradation profiles of degradable materials.

FIG. 3 shows a cross-section of a substrate with one conformal coating that acts as a barrier to a foreign environment, according to an embodiment.

FIG. 4 shows a cross-section of a substrate with two conformal coatings that act as a barrier to a foreign environment, according to an embodiment.

FIG. 5 shows a cross-section of a substrate with a liquid impregnated surface (with subtractive texturing) that acts as a barrier to a foreign environment, according to an embodiment.

FIG. 6 shows a cross-section of a substrate with a liquid impregnated surface (with subtractive texturing) on top of a conformal coating that acts as a barrier to a foreign environment, according to an embodiment.

FIG. 7 shows a cross-section of a substrate with a liquid impregnated surface (additive texturing) that acts as a barrier to a foreign environment, according to an embodiment.

FIG. 8 shows a cross-section of a substrate with a liquid impregnated surface (additive texturing) on top of a conformal coating that acts as a barrier to a foreign environment, according to an embodiment.

FIG. 9 illustrates the time evolution of the mass of each of the sugar cubes normalized to its initial mass, according to an embodiment.

FIG. 10 illustrates the time evolution of the mass of each of the sugar cubes normalized to its initial mass, according to an embodiment.

FIG. 11 shows a cross-section of a substrate with a barrier implemented with a fuse trigger mechanism that can be used to control the degradation behavior of the barrier/substrate system in a foreign environment, according to an embodiment.

FIG. 12 shows a cross-section of a substrate with a barrier and an underlying dissolvable layer implemented with a trigger mechanism that can be used to control the degradation behavior of the barrier/substrate system in a foreign environment, according to an embodiment.

FIG. 13 shows a cross-section of a substrate with a barrier implemented with a through-the-substrate trigger mechanism that can be used to control the degradation behavior of the barrier/substrate system in a foreign environment, according to an embodiment.

FIG. 14 shows a cross-section of a substrate with a barrier implemented with two independent trigger mechanisms that can be used to control the degradation behavior of the barrier/substrate system in a foreign environment, according to an embodiment.

### DETAILED DESCRIPTION

Degradable materials are widely used in oil and gas field exploration, production, and testing. For example, some drilling technologies in the oil and gas industry use engineered materials with highly specialized degradation properties suitable for specific downhole applications. The degradable materials can include metal alloys, and are often deployed in harsh environments. For example, the degradable materials can be used in the presence of brine and/or in the presence of other fluids with varying pH and salinity, and can be subjected to high temperature and/or pressure.

One particular example of a technology used in the oil and gas industry that can utilize degradable materials is a “plug-and-perf” system. Plug-and-perf systems are used in hydraulic fracturing to temporarily seal off the sections of the well bore that are being subjected to stimulation. In certain situations, it is desirable for the degradable plug to last at least as long as the duration of the stimulation event before the onset of degradation. Failure to do so can result in significant structural damage to the well bore, which may impede the impending drilling operations.

Another example of a technology in the oil and gas industry that can utilize degradable materials is a sliding sleeve. Sliding sleeves are used in hydraulic fracturing to fluidically isolate one or more reservoir zones or to regulate pressure between zones. In certain situations, it may be desirable for the sliding sleeve to be degradable. Such a degradable sliding sleeve can reduce or eliminate reliance on mechanical intervention (e.g. with wireline or coiled tubing), which in turn can reduce or eliminate lateral length restrictions in order to maximize reservoir contact and estimated ultimate recovery. In some embodiments, the degradable sliding sleeve can be configured to remain intact for longer or shorter periods of time, depending on the length of a stimulation event, or multiple stimulation events. The degradable sliding sleeve can also be configured to completely degrade so that the well is left with full-bore access. In other words, once the degradable sliding sleeve has served its initial purpose and then completely degrades, well production is left unimpeded without the need for mechanical intervention.

Liquid-impregnated surfaces can be particularly effective in preventing corrosion of sliding sleeves. These sleeves are currently prone to attacked by acids that are used for stimulation, and this corrosion hinders their functionality, so they cannot be actuated in the future. A liquid-impregnated surface can be configured to prevent or inhibit corrosion, thus leaving their functionality intact. In addition, since the sleeves with liquid impregnated surfaces are not prone to degradation, they can be made thinner (i.e., reduced wall thickness), thereby creating a larger flow area and allowing a higher production rate.

Given the wide variation of downhole conditions, the degradation profile of a degradable plug, sliding sleeve, or any of the equipment referenced above can vary widely. For example, in certain conditions where a degradable material and/or equipment is subjected to very high pressure, temperature, highly acidic, and/or high salinity, the components can degrade much faster than in “milder” conditions. Furthermore, pinholes, defects, and scratches on downhole equipment (or coatings thereof) can create pathways for corrosive materials to react and corrode the equipment. Said another way, the degradation profile of any degradable material can be unpredictable under various operating conditions.

Thus, there is a need for systems and methods that inhibit corrosion and/or enable controlling (e.g., prolong or delay) the degradation profile of degradable materials. Similarly, there is a need for systems and methods that can be used to trigger and/or otherwise initiate the degradation of the degradable materials at a specific time or in the event of exposure to a specific set of environmental conditions. Said another way, the ability to control and engineer the degradation behavior of degradable materials without changing the nature or composition of the degradable material itself can be technically and economically very beneficial.

Embodiments described herein relate generally to a system and methods for controlling and/or modifying the degradation behavior of degradable materials via a surface treatment and/or coating. This surface treatment and/or coating (also referred to herein as a “barrier”) can be used to modify the degradation profile without changing the bulk of the degradable material. In other words, the degradation profile of any given material can be customized and/or engineered using the surface treatments and/or coatings described herein. For example, the systems and methods described here can be used to extend the lifetime of a tool or a component made from a degradable material far beyond the typical degradation time of the underlying degradable material itself. The advantages of these engineered surface treatments would not only benefit the wide range of existing applications for degradable materials (e.g. in oil and gas, and medical industries) but can also create entirely new markets and applications for these materials.

In some embodiments, certain materials can be paired with a coating and/or a trigger described herein, such that the material, devices, or equipment can be made degradable on command or over a targeted time. Other examples of devices and systems that can utilize degradable materials include applications, such as seals, packers, projectiles, guns, liners pumps and motors, and their components, shrouds and screens, ball drop systems, plug and perf systems or components, collars, packers, anchors, tubing, liners, flow columns, casings, sensors, valves, sensors, locks, actuators, cables, sheets, connectors, centralizers, drilling equipment, joints, mandrels, seating and landing nipples, mud handling equipment.

In some embodiments, the degradation of a component can be used to actuate the movement of downhole systems, for example by dissolving of a load bearing component of a device or system. Coatings, such as liquid impregnated surfaces described herein, can be used for sampling containers, to reduce or eliminate scavenging, and to allow for accurate concentration measurements. The degradation of a component can be configured to open or close an electric circuit, or to enable the flow of ions. The triggered degradation can also trigger a chemical reaction (e.g. by triggering the degradation of a barrier between multiple reactants).

Further, liquid impregnated surfaces are free of pinhole or other defects, and can self-heal (filling scratches). Therefore, when made from nonreactive/chemically inert materials (e.g., fluorinated or syliconyl materials), they are highly effective anti-corrosion coatings. This can be favorable for downhole equipment, where they protect various equipment and components (such as those described elsewhere in the specifications) from corroding in harsh downhole chemistries, such as, for example, H₂S, CO₂, brine, and oxygen rich fluids, such as mud.

In addition, liquid-impregnated surfaces can be particularly effective in preventing corrosion of sliding sleeves, which, at present, are prone to attack by acids that are used for stimulation. This corrosion hinders their functionality, and therefore they cannot be actuated for future use. With liquid-impregnated surfaces, the sleeves would not corrode and their functionality would remain intact. Additionally, since the sleeves are not prone to degradation, they can be made thinner (e.g., reduced wall thickness), thereby creating a larger flow area to allow a higher production rate.

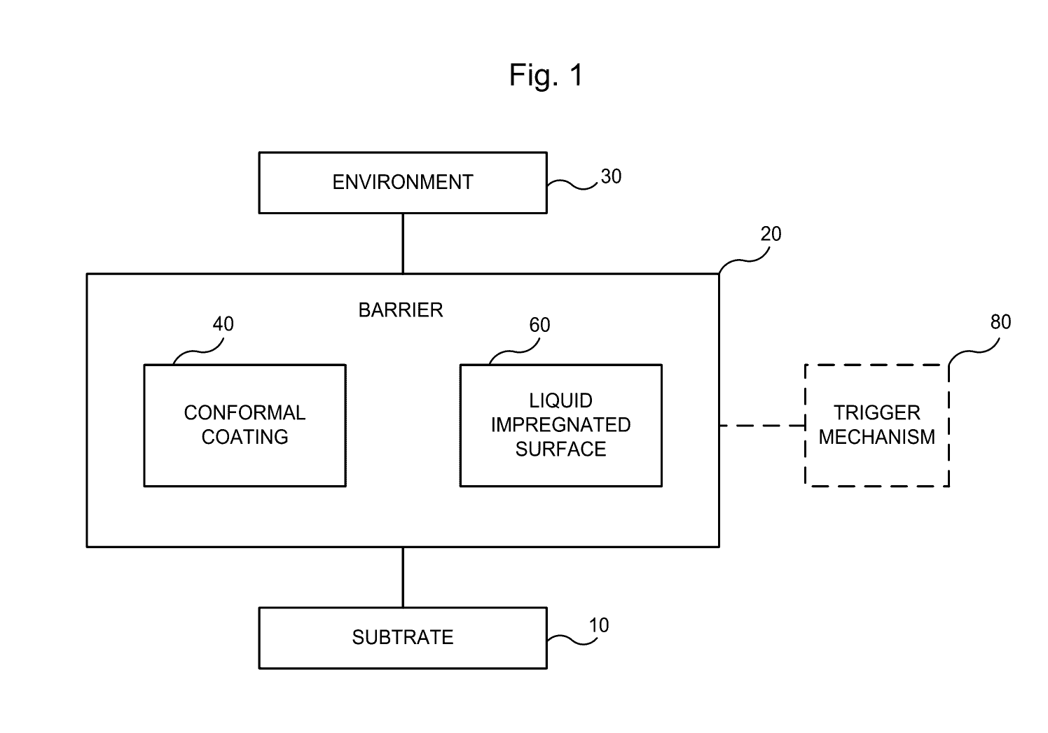

FIG. 1 is a schematic illustration of a system for controlling the degradation profile of a degradable material. The system includes a substrate 10 that includes a degradable material and barrier 20 configured to protect the substrate 10 from a target environment 30. The barrier 20 can include a conformal coating 40 and/or a liquid impregnated surface 60 engineered specifically to tailor the degradation profile of the underlying substrate 10. Optionally, a trigger mechanism 80 can be used to initiate, further control, and/or modify the degradation behavior of the substrate 10.

As described herein, the substrate 10 can include one or more degradable materials, including those designed to specifically disintegrate, dissolve or fragment under well-defined conditions within a certain period of time. The substrate 10 can be formed entirely or partially from degradable materials, and can be homogeneous, heterogeneous and/or porous. Examples of degradable materials include inorganic-based metals, metal alloys, ceramics, synthetic organic-based plastics, and polymers. Some degradable metal alloys used in oil field exploration, production, and testing can include alloys of reactive metals selected from products in columns I and II of the periodic table and alloying products, such as gallium (Ga), indium (In), Zinc (Zn), Bismuth (Bi) and Aluminum (Al). Examples of degradable materials are described in U.S. Pat. No. 8,211,247 (“the '247 patent”), entitled “Degradable Compositions, Apparatus Comprising Same, and Method of Use.” The substrate 10 can also include other degradable materials including, but not limited to, nanomatrix powder metal compacts with Mg, Al, Zn or Mn, or a combination thereof, dispersed in the cellular nanomatrix, as described in U.S. Pat. No. 4,038,228, entitled “Degradable Plastic Composition Containing a Transition Metal Salt of a Highly Unsaturated Organic Acid,” or in water-soluble degradable synthetic vinyl polymers, as described in PCT Publication No. WO 2011/135,313, entitled “Water-Soluble Degradable Synthetic Vinyl Polymers and Related Methods.” The substrate 10 can also include degradable biomaterials such as, for example, polymers, polycaprolactone, polyesters and aromatic-aliphatic esters, poly-3-hydroxybutyrate, poly lactic acid (PLA), poly(e-caprolactone) (PCL), polycaprolactone, cellulose-based materials, such as cellulose acetate and cellulose nitrate, as well as metals, Mg- and Fe-based alloys, such as Mg—Al based alloys, Mg-RE (rare earth) based alloys, Mg—Ca based alloys, pure Fe, Fe—Mn alloys, Zinc and bulk metallic glasses.

As described herein, the degradable material (or materials) incorporated into the substrate 10 can be configured to degrade within 1 second, 2 seconds, 3 seconds, 4 seconds, 5 seconds, 10 seconds, 20 seconds, 30 seconds, 40 seconds, 50 seconds, 1 minute, 2 minutes, 3 minutes, 4 minutes, 5 minutes, 10 minutes, 20 minutes, 30 minutes, 40 minutes, 50 minutes, 1 hour, 2 hours, 3 hours, 4 hours, 5 hours, 6 hours, 12 hours, 24 hours, 1 day, 2 days, 3 days, 4 days, 5 days, 6 days, 1 week, 2 weeks, 3 weeks, 4 weeks, 1 month, 2 months, 3 months and so on, as described in the '247 patent.

In some embodiments, the substrate 10 can have a surface that has inherent surface structures, and/or a surface that is chemically and/or physically modified. For example, the substrate 10 can have a surface that is flat, bumpy, smooth, textured with regular periodic patterns, or textured with random shapes and contours. In some embodiments, the substrate 10 can be etched, sandblasted, engraved, or otherwise have material subtracted (e.g., removed) from its surface to create the textured surface. In other embodiments, the substrate 10 can have materials added (e.g., deposited) to its surface to create the textured surface. In some embodiments, the substrate 10 can have texture or roughness formed into the surface (e.g. by embossing, knurling, or stamping). In some embodiments, the substrate 10 can have a surface texture formed during and/or after the creation of the substrate 10 without any subsequent modification to its surface.

In some embodiments, the barrier 20 can be any added protective coating and/or any surface treatment or modification that is configured or formulated to protect the substrate 10. The barrier 20 can be engineered to control the degradation behavior of the substrate 10 by utilizing one or more technical approaches, including but not limited to, conformal coatings 40 and/or liquid impregnated surfaces 60 disposed on the substrate 10. The barrier 20 can include any number of conformal coatings 40 and any number of liquid impregnated surfaces 60. Said another way, the barrier 20 can include, for example, one conformal coating 40 without a liquid impregnated surface 60, multiple conformal coatings 40 without a liquid impregnated surface 60, one liquid impregnated surface 60 without any conformal coatings 40, multiple liquid impregnated surfaces 60 without any conformal coatings 40, one conformal coating 40 and one liquid impregnated surface 60, and so on. The conformal coating 40 can include different materials in any number of layers and in any order. The liquid impregnated surface 60 can be disposed on the substrate 10 directly, or on the conformal coating 40. Similarly, the conformal coating 40 can be disposed on the substrate 10 directly, or on the liquid impregnated surface 60. The substrate 10 and the barrier 20 may be contained within an environment 30 consisting of one or more layers of degradable materials, each of which may be covered by its own barrier.

In some embodiments, the composition of the conformal coating 40 can be a homogeneous solid or a gel (hydrogel, aerogel) material. In some embodiments, the conformal coating 40 can be heterogeneous and can include a mixture (e.g., composite) of solid and/or gel materials. In some embodiments, the conformal coating 40 can include a plurality of coatings and portion of the coatings can be homogeneous and a portion of the coatings can be heterogeneous material. The selection of coating materials and/or number of coatings allows for the customization of the barrier 20 and/or the degradation profile of the underlying substrate 10. Said another way, the conformal coating 40 materials and/or layers can be selected to provide mechanical abrasion resistance, while other conformal coating 40 materials can be selected to provide chemical barrier properties. For example, a first conformal coating layer (not shown) can be disposed on the substrate 10 that provided a chemical barrier, while a second conformal coating layer (not shown) can be disposed on the first conformal coating layer that provides a mechanical barrier to protect the first conformal coating layer. Similarly, a single composite conformal coating 40 can include two or more materials selected to have different properties to achieve a similar objective (i.e., combined chemical and mechanical barrier).

As described herein, the conformal coating 40 can include one or more members from the following list of materials: ceramic, plastic, metal, and polymer, including but not limited to fluorinated polymer, Polytetrafluoroethylene (PTFE), Polyvinylidene fluoride (PVDF), poly(p-xylylene) polymers, poly(perfluorodecylacrylate) (PFDA), polymethylmethacrylate (PMMA), polyglycidylmethacrylate (PGMA), poly-2-hydroxyethylmethacrylate, poly(perfluorononyl acrylate), poly(perfluorooctyl acrylate), poly(3,3,4,4,5,5,6,6,7,7,8,8,8-tridecafluorooctyl methacrylate), poly(1H,1H,2H,2H-perfluorooctyl acrylate), poly([N-methyl-perfluorohexane-1-sulfonamide]ethyl acrylate), poly([N-methyl-perfluorohexane-1-sulfonamide]ethyl(meth)acrylate), poly(2-(Perfluoro-3-methylbutyl)ethylmethacrylate)), poly(2-[[[[2-(perfluorohexyl)ethyl]sulfonyl]methyl]-amino]ethyl]acrylate), poly(2-[[[[2-(perfluoroheptyl)ethyl]sulfonyl]methyl]-amino]ethyl]acrylate), poly(2-[[[[2-(perfluorooctyl)ethyl]sulfonyl]methyl]-amino]ethyl]acrylate), and any copolymer thereof, and may be cross-linked with a member selected from the group consisting of ethylene dimethyacrylate (EDMA), di(ethyleneglycol)di(methacrylate), di(ethyleneglycol)di(acrylate), ethyleneglycoldimethyacrylate (EGDMA), parylene-N, parylene-C, parylene-D, parylene-HT, di(ethyleneglycol)di(vinylether) (EDGDVE), 1H,1H,6H,6H-perfluorohexyldiacrylate, diethyleneglycol divinyl ether, and divinyl benzene (DVB); diamond-like carbon, SiO₂, SiN, TiO₂, TiN, SiC, cyclic siloxanes such as 1,3,5-trivinyl-1,3,5-trimethylcyclotrisiloxane (V3D3), zwitterionic polymers, as described in U.S. Patent Publication No. 2014/0299538, entitled “Antifouling and Chlorine-Resistant Ultrathin Coatings on Reverse Osmosis Membranes,” or impermeable polymers such as copolymers of 4-aminostyrene and maleic anhydride, as described in U.S. Pat. No. 8,552,131, entitled “Hard, Impermeable, Flexible and Conformal Organic Coatings,” the disclosures of which are incorporated herein by reference in their entireties. The conformal coating 40 can include a metal, such as Gold (Au), Chromium (Cr), Aluminum (Al), Platinum (Pt), Copper (Cu), or Nickel (Ni). The conformal coating 40 can also include a gel (hydrogel, aerogel), a membrane such as a polar membrane composed of a lipid bilayer, or of a carbon nanotube or graphene based membrane, as described in the U.S. Patent Publication No. 2014/0314982, entitled “Grafted Polymer Surfaces for Dropwise Condensation, and Associated Methods of Use and Manufacture,” the disclosure of which is incorporated herein by reference in its entirety.

In some embodiments, the conformal coating 40 can include any of the aforementioned materials disposed on the substrate 10 via any suitable deposition technique or methodology. The conformal nature of the coating can ensure that the entire surface of the substrate 10 is covered without any pin-hole or voids forming within the coating or on the surface of the coating. In other words, the conformal coating 40 can be used to substantially encapsulate the substrate 10. The conformal coating 40 can be disposed on the substrate 10 using any of a number of widely used coating techniques including, but not limited to, chemical vapor deposition (CVD) (including initiated CVD, hot-wire CVD, plasma enhanced CVD, and other forms of CVD), physical vapor deposition, sputter deposition, magnetron sputtering, radio frequency sputtering, atomic layer deposition, pulsed laser deposition, electroplating, dip-coating, brushing, spray-coating, sol-gel chemistry (through dip-coating, brushing or spray-coating), electrostatic spray coating, 3D printing, spin coating, electrodeposition, powder coating, sintering, self-assembly of monomers and self-assembly of particles. The conformal coating 40 can also be applied by dipping the entire substrate 10 into a liquid that then hardens to form a “cast” either after removal from the liquid or in a mold that is holding the liquid. Any excess material can then be removed to achieve the desired overall part dimensions by machining, grinding, cutting, or another technique.

In some embodiments, the properties the conformal coating 40 can be optimized during the deposition by varying deposition parameters. Physical properties such as, for example, coating texture, coating thickness, thickness uniformity, surface roughness, porosity and general mechanical elastic properties, including fracture toughness, ductility, abrasion resistance can be optimized via fine tuning of deposition parameters. Chemical properties such as, for example, chemical resistance and corrosion resistance (from acid, base and salts), along with other chemical properties, including specific reactivity, adhesion, affinity, hydrophobicity, hydrophilicity, chemical potentials, work functions and general surface energies can be also optimized for producing high quality conformal coating 40. In some embodiments, various physical and chemical properties of the conformal coating 40 can be further improved or modified post deposition by a subsequent surface or temperature treatment, such as annealing or rapid-thermal (flash) annealing.

As described herein, the conformal coating 40 can have one or more desirable properties. In some embodiments, the conformal coating 40 can have a sufficiently low permeability for one or more active species, including but not limited to chemical species, biological species and/or any other species required to trigger and sustain the degradation of the substrate 10. In other words, the conformal coating 40 can have a sufficiently low permeability such that the exchange of a chemicals species between the substrate 10 and the target environment 30 occurs at a low enough rate to prevent decomposition of the substrate 10 during its intended lifetime.

In some embodiments, the conformal coating 40 meets the environmental, health and safety requirements of the application in which the substrate 10 is exposed.

In some embodiments, the conformal coating 40 can have low enough solubility in the target environment 30 such that the integrity of the conformal layer 40 is maintained for the desired lifetime of the substrate 10.

In some embodiments, the melting point of the conformal coating 40 can be sufficiently high such that integrity of the conformal coating is maintained for the desired lifetime of the substrate 10 in the target environment 30.

In some embodiments, the conformal coating 40 can sufficiently bond to the substrate 10 such that it can withstand mechanical abrasion during transportation and deployment. Further abrasion resistance can be provided by additional coating layers deposited on top of the first conformal coating 40.

In some embodiments, the conformal coating 40 can be covalently grafted to the surface of the substrate 10. This deposition approach can be accomplished using a vinyl precursor that comprises at least one member selected from the group consisting of trichlorovinylsilane, bis(triethoxysilylethyl)vinylmethyl-silane, bis(triethoxysilyl)ethylene, bis(trimethoxysilylmethyl)ethylene, 1,3-[bis(3-triethoxysilylpropyl)poly-ethylenoxy]-2-methylenepropane, bis[(3-trimethoxysilyl)propyl]-ethylenediamine, bis[3-(triethoxysilyl)propyl]-disulfide, 3-mercaptopropyltrimethoxysilane, and vinyl phosphonic acid.

In some embodiments, the formation of reactive surface sites on the conformal coating 40 or the substrate 10 can be achieved using plasma activation or exposing to a plurality of free radical species, as described in U.S. Patent Publication No. 2013/0280442, entitled, “Adhesion Promotion of Vapor Deposited Films.”

In some embodiments, the conformal coating 40 can include a chemically active species that is released into the target environment 30 over time. In some embodiments, the chemically active species can either catalyze or inhibit the degradation of the substrate 10. For example, release of hydroxide anions can inhibit a degradation reaction that relies on an acidic environment.

In some embodiments where the conformal coating 40 includes a polymer layer, the conformal coating 40 can includes capsules or voids filled with a “self healing agent”, which can then be released and react to “heal” any damage that has occurred to the solid conformal coating 40.

In some embodiments, the conformal coatings 40 can have individual or combined total coating thickness of about 1 nm to about 100 nm, about 100 nm to about 1 μm, about 1 μm to about 10 μm, about 10 μm to about 100 μm, about 100 μm to about 1 mm, or about 1 mm to about 10 mm.

In some embodiments, the degradation of the substrate 10 can be initiated and sustained by contact with a chemical species in the target environment 30. This exposure can be controlled by adjusting the fraction of the surface area of the substrate 10 which is in direct contact to the environment 30 and/or by controlling the rate at which the chemical species in the environment 30 arrive at the surface of the substrate 10. In some embodiments, the conformal coating 40 can be selected based on its selective permeability for a specific chemical species. For example, the conformal coating 40 can be permeable for the reactants that are required for the degradation of the substrate 10, but not for the reaction products. This selective permeability can be used to shift the reaction balance between reactants and products.

In some embodiments, the degradation of the substrate can be initiated and sustained by contact with chemical species in its target environment. A surface treatment/coating can therefore be used to modify the degradation rate and/or the degradation delay of the substrate by controlling the exposure of the substrate to the target environment. This exposure can be controlled by adjusting the fraction of the surface area of the substrate which is in direct contact to the environment and/or by controlling the rate at which the chemical species in the environment arrive at the substrate surface.

In some embodiments, the permeability of the conformal solid coating 40 can be adjusted to modify the degradation rate and thus the lifetime of the substrate this can be achieved for instance by controlling the film chemistry, porosity and thickness. It is also contemplated that the conformal solid coating 40 can be selected based on its selective permeability for the chemical species. For example, the solid can be permeable for the reactants that are required for the degradation of the substrate but not for the reaction products. This selective permeability can be used to shift the reaction balance between reactants and reaction products.

In some embodiments, the integrity of the covalent solid layer can be adjusted to control the area of the surface of the substrate which is in direct contact to the environment. For example, a certain pin-hole density can be introduced into the solid layer or by only coating selected areas of the sample, leaving other areas unprotected.

In some embodiments, the degradation of the conformal solid layer itself can be tuned by adjusting its properties. For example, selecting a solid with a suitable melting point such that the coating melts after exposure to the environmental temperature. Alternatively, by selecting a solid material (or materials) with finite miscibility with the target environment, other coating components and/or the substrate.

In some embodiments, the adhesion/affinity of the conformal solid coating 40 to the substrate can be tuned to make it more or less susceptible to external influences such as mechanical abrasion.

In some embodiments, the reactivity and/or the electrochemical potential of the solid layer with respect to the environment can be chosen in such a way that the solid layer degrades slower or faster in its environment.

As described herein, the barrier 20 can include a liquid impregnated surface 60 in addition to, or instead of, the conformal coating 40. In some embodiments, the liquid impregnated surface 60 includes any and all solid surfaces, coatings and/or structures on surfaces that are partially or completely covered or impregnated or infused by a liquid or semi-solid layer of another material, where the liquid or semi-solid layer remains liquid or semi-solid at any point during its use, and is substantially immiscible with another product or material that is in contact with said surface at any point during its use. The solid features (also referred to herein as “texture”) can be inherent to a substrate or can be created by chemical and/or mechanical surface treatment of an existing surface or by depositing a texture onto an existing surface. Examples of liquid impregnated surfaces 60 that can bused in the barrier 20 are described in U.S. Pat. No. 8,574,704 (“the '704 patent”), entitled “Liquid-Impregnated Surfaces, Methods of Making, and Devices Incorporating the Same,” U.S. Patent Publication No. 2014/0178611 (“the '611 publication”), entitled “Apparatus and Methods Employing Liquid-Impregnated Surfaces,” and U.S. Patent Publication No. 2014/0314975 (“the '975 publication”), entitled “Methods and Articles for Liquid-Impregnated Surfaces with Enhanced Durability,” the disclosures of which are incorporated herein by reference in their entireties.

As described herein, the liquid impregnated surface 60 can include a liquid either alone or in a combination, including but not limited to silicone oil, a perfluorocarbon liquid, halogenated vacuum oil, greases, lubricants, (such as Krytox 1506 or Fomblin 06/6), a fluorinated coolant (e.g., perfluoro-tripentylamine sold as FC-70, manufactured by 3M), a gel (e.g. hydrogels and organogels), an ionic liquid, a fluorinated ionic liquid that is immiscible with water, a silicone oil comprising PDMS, a fluorinated silicone oil such as, for example polyfluorosiloxane, or polyorganosiloxanes, a liquid metal, a synthetic oil, a vegetable oil, an electro-rheological fluid, a magneto-rheological fluid, a ferrofluid, a dielectric liquid, a hydrocarbon liquid such as mineral oil, crude oil, and refined crude oil, polyalphaolefins (PAO), or other synthetic hydrocarbon co-oligomers, a fluorocarbon liquid, for example, polyphenyl ether (PPE), perfluoropolyether (PFPE), or perfluoroalkanes, a refrigerant, a vacuum oil, a phase-change material, a semi-liquid, polyalkylene glycol, esters of saturated fatty and dibasic acids, polyurea, grease, synovial fluid, bodily fluid, or any other aqueous fluid or any other impregnating liquid described herein or any combination thereof. It is also contemplated that the liquid which is included in the liquid impregnated surface 60 is a component of the environment 30.

In some embodiments, a plurality of solid features (also referred to herein as a “matrix of solid features”) of the liquid impregnated surface 60 can be created by any one or a combination of the following methods, including but not limited to any form of mechanical abrasion, such as polishing, sandblasting, rubbing with sandpaper, dry ice blasting, as well as machining techniques, such as milling, drilling, filing, cutting, high pressure cutting/machining, such as with a water-jet, laser cutting or laser rastering.

In some embodiments, a matrix of solid features of the liquid impregnated surface 60 can be created by any form of dry etching, such as plasma etching, reactive ion etching, deep reactive ion etching, sputter etching, ion milling, and vapor phase etching.

In some embodiments, a matrix of solid features of the liquid impregnated surface 60 can be created by any form of wet etching, such as exposure to acid or base solutions, exposure to ionic liquids and boiling in solvents.

In some embodiments, a matrix of solid features of the liquid impregnated surface 60 can be created by anodization, electrodissolution, stamping or embossing, and by common manufacturing processes of the substrate 10, such as casting or sintering (powder sintering).

In some embodiments, a matrix of solid features of the liquid impregnated surface 60 can be created by corona etching, heat treatment, flame treatment, plasma treatment, and irradiation.

In some embodiments, a matrix of solid features of the liquid impregnated surface 60 can be formed from a collection or coating of particles including, but not limited to insoluble fibers (e.g., purified wood cellulose, micro-crystalline cellulose, and/or oat bran fiber), wax (e.g., carnauba wax, Japan wax, beeswax, rice bran wax, candelilla wax, fluorinated waxes, waxes containing silicon, waxes of esters of fatty acids, fatty acids, fatty acid alcohols, glycerides, etc.), other polysaccharides, fructo-oligosaccharides, metal oxides, montan wax, lignite and peat, ozokerite, ceresins, bitumens, petrolatuns, paraffins, microcrystalline wax, lanolin, esters of metal or alkali, flour of coconut, almond, potato, wheat, pulp, zein, dextrin, cellulose ethers (e.g., Hydroxyethyl cellulose, Hydroxypropyl cellulose (HPC), Hydroxyethyl methyl cellulose, Hydroxypropyl methyl cellulose (HPMC), Ethyl hydroxyethyl cellulose), ferric oxide, ferrous oxide, silicas, clay minerals, bentonite, palygorskite, kaolinite, vermiculite, apatite, graphite, molybdenum disulfide, mica, boron nitride, sodium formate, sodium oleate, sodium palmitate, sodium sulfate, sodium alginate, agar, gelatin, pectin, gluten, starch alginate, carrageenan, whey and/or any other edible solid particles described herein or any combination thereof.

In some embodiments, a matrix of solid features of the liquid impregnated surface 60 can be formed by application of polymeric materials including, but not limited to polymers, fluorinated polymers, fluorinated waxes, perfluorinated polymers, plastic, glass, metal, ceramics, polystyrene, nylon, polypropylene, wax, polyethylene terephthalate, polypropylene, polyethylene, polyurethane, polysulphone, polyethersulfone, polytetrafluoroethylene (PTFE), tetrafluoroethylene (TFE), fluorinated ethylenepropylene copolymer (FEP), polyvinylidene fluoride (PVDF), perfluoroalkoxytetrafluoroethylene copolymer (PFA), perfluoromethyl vinylether copolymer (MFA), ethylenechlorotrifluoroethylene copolymer (ECTFE), ethylene-tetrafluoroethylene copolymer (ETFE), polychlorotetrafluoroethylene (PCTFE), polyvinyl alcohol (PVA), polyethyleneglycol (PEG), polyfluoropolyether (PFPE), poly(acrylic acid), poly(propylene oxide).

In some embodiments, a matrix of solid features of the liquid impregnated surface 60 can be created by all of the above in combination with lithographic techniques that result in selective exposure of parts of the substrate to the above texture creation methods.

In some embodiments, the impregnating liquid of the liquid impregnated surface 60 can be applied by any system and method including, but not limited to, the systems and methods described in the '704 patent and the '611 publication incorporated by reference above. In addition, other techniques including, but not limited to, dip coating, brush coating, spin coating and spray coating, as well as vacuum impregnation in which the substrate 10 and the impregnating liquid are both subject to a reduced pressure environment (vacuum). Exposing the substrate 10 to vacuum has the advantage that air is removed from features and/or pores of the substrate 10, prior to applying the liquid. In the vacuum environment, the substrate 10 is then immersed in the liquid. In the next step, the pressure is increased back to atmospheric level. This can be followed by application of one or several cycles of higher than atmospheric pressure, to push the liquid into any open pores or features of the substrate 10.

In some embodiments, the impregnating liquid can have a higher viscosity (up to 1000 PaS) than the liquids described in the '704 patent and the '611 publication. In some embodiments, the liquid impregnated surface 60 can have a sufficiently low permeability with respect to a chemical species present in the target environment 30 that can initiate and/or sustain degradation of the substrate 10. In other words, the liquid impregnated surface 60 can have a sufficiently low permeability such that the exchange of a chemicals species between the substrate 10 and the target environment 30 occurs at a low enough rate to prevent decomposition of the substrate 10 during its intended lifetime. For some applications, it may be desirable to choose an impregnating liquid with contact angle of zero on the solid features, such that the solid features are completely submerged (φ=0), as described in the '611 publication incorporated by reference above.

In some embodiments, the liquid impregnated surface 60 meets the environmental, health and safety requirements of the target environment 30 in which the substrate is deployed. In some embodiments, the liquid impregnated surface 60 can have a sufficiently low contact angle on the substrate 10 such that the liquid “re-wet” the substrate 10 in places where the liquid impregnated surface 60 has been damaged due to, for instance mechanical abrasion (e.g. the liquid-impregnated surface is self-healing).

In some embodiments, the liquid impregnated surface 60 can be customized to control the degradation profile of the substrate 10, and therefore the lifetime of the substrate 10. For example, excess liquid can supplied to the liquid-impregnated surface 60 to completely submerge the matrix of solid featured in the liquid. Over time (e.g., due to gravity), the liquid will drain from the matrix of solid features until the liquid-impregnated surface reaches its thermodynamic equilibrium, which is associated with a finite φ (fraction of emerged solid). By adjusting the liquid viscosity, the time period over which drainage occurs can be modified and thus exposure of the substrate surface to the environment can be controlled.

In some embodiments, a substantially similar effect can be achieved by adjusting the complexity of the solid surface to achieve a certain drainage rate (higher complexity results in slower drainage and vice versa). It is contemplated that the complexity of the surface can be modified over time, while being exposed to the target environment. This modification would then result in a change in the drainage behaviour of the liquid. The modification in complexity of the surface can be achieved, for example, by selecting an appropriate melting point for the material which constitutes the matrix of solid features, such that by melting, the complexity of the surface is reduced.

In some embodiments, the permeability of the impregnating liquid to a chemical species present in the environment can also be adjusted to modify the degradation rate. This can be achieved by adjusting the liquid chemistry or changing the liquid thickness.

While a liquid with zero contact angle on the substrate would result in φ=0, i.e., no emerged solid, liquids with φ>0 would result in φ>0 and thus a finite area of the substrate would be exposed to the environment. Controlling the contact angle of the liquid, thus can also be used to modify the degradation of the substrate.

In some embodiments of the liquid-impregnated surface 60, a loss of liquid results in an increase in φ (fraction of emerged solid). Thus, by controlling the loss of liquid while the substrate is deployed in its target environment 30, the degradation can be modified. The following methods can be used to control the loss of liquid: (1) selecting a liquid with a suitable boiling point such that liquid evaporates over time, (2) selecting a liquid with suitable finite miscibility with the target environment and/or other coating components, (3) selecting a liquid with a suitable reactivity such that it is used up within a certain time by reacting with chemical species in the environment, (4) adding a surfactant to the impregnating liquid to modify its boiling point as well as its miscibility or its ability to be emulsified in the environment (examples of which can be found in U.S. patent application Ser. No. 14/668,444, the disclosure of which is incorporated herein by reference in its entirety), (5) selecting the liquid viscosity and/or adjusting the liquid viscosity by adding particles or thickeners to the liquid in order to control entrainment of the liquid in the environment due to shear forces, gravity or any other external forces (e.g., a higher viscosity liquid would result in a reduce of the liquid loss due to shear forces, the liquid can be shear-thickening, shear thinning, a Bingham plastic or a semi solid, which would allow it to actively react to changes in external forces, etc.).

FIG. 1 also illustrates the use of a trigger mechanism 80 that can be implemented in the barrier 20 that is disposed on the substrate 10. The trigger mechanism 80 can include any mechanism that causes or facilitates the timing, functions and/or properties of the barrier 20 in respect to the degradation behavior of the underlying degradable substrate 10. Depending on the environment and the barrier 20's surroundings, a trigger mechanism 80 can be remotely triggered or programmed to respond to the changing environments and surroundings. In some embodiments, the trigger mechanism 80 can be used to delay the degradation rate of the substrate 10 in a specific set of brine conditions with a prescribed range of parameters including pH, salinity, temperature and/or pressure. In general, the trigger mechanism 80 can include, but not limited to exposure to a chemical trigger, ultraviolet exposure or any programmable triggering mechanism with tunable range of operations for aforementioned chemical and physical changes in the surroundings. By appropriate modification and engineering of the barrier 20 and trigger mechanism 80, the onset of degradation of the substrate 10 can be delayed or accelerated and/or its degradation profile can be controlled to achieve targeted protection specifications.

In some embodiments, the following or a combination of the following mechanisms 80 could be employed to externally trigger degradation of the substrate 10 at an earlier time or at a higher degradation rate than would be expected from the coated substrate 10 alone (e.g. reduce lifetime of the substrate 10).

In some embodiments, the trigger mechanism 80 can be used to initiate the degradation process of the substrate 10 at a predetermined time and/or under predetermined conditions. For example, trigger mechanisms 80 for the conformal coating 40 can include locally removing a portion of the conformal coating 40 through mechanical abrasion of the conformal coating 40, such as punctuation or scratching, which could be achieved through contact of the substrate 10 with a sharp object in its immediate environment 30. Such mechanical abrasion of the conformal coating 40 can be triggered electrically, mechanically, or hydraulically. Another example of a trigger mechanism 80 can include melting at least a portion of the conformal coating 40 by increasing the temperature in the environment 30 of the substrate 10. This can be accomplished by “globally” increasing the temperature of the environment 30 or by locally increasing the temperature of the conformal coating 40 or the substrate 10 with a thermoelement in proximity to the substrate 10 and/or through localized irradiation. Another example of a trigger mechanism 80 can include increasing the solubility of the conformal coating 40 (e.g., solid) in environment 30, for example by releasing solvents into the environment 30.

In some embodiments, examples of trigger mechanisms 80 for the liquid impregnated surface 60 can include removing a portion of the liquid from the liquid impregnated surface 60 (i.e., to increase φ), increasing solubility or ease of emulsification of the impregnating liquid in the environment 30 (e.g., by releasing solvents or surfactants into the environment 30), increasing evaporation of the impregnating liquid by increasing the temperature of the environment 30 (e.g., around the substrate 10), and applying a pressure gradient across the substrate 10 to manipulate the rate of drainage of excess impregnating liquid.

In some embodiments, the trigger mechanism 80 can be used regardless of the composition of the barrier 20. For example, some trigger mechanism 80 can be used to initiate degradation of the substrate 10 regardless of whether a conformal coating 40 or a liquid impregnated surface 60 (or any combination thereof) is used as the barrier 20. In some embodiments, the trigger mechanism 80 can be used to externally trigger the degradation of the substrate 10 at a predetermined time and/or at a lower degradation rate (e.g., to extend the life of the substrate 10). For example, the trigger mechanism 80 can include reducing the concentration of a chemical species responsible for the degradation of the substrate 10 in the environment 30 (e.g., globally or locally). The trigger mechanism 80 can include releasing chemicals that can neutralize any chemical species present in the environment 30 responsible for the degradation of the substrate 10 (e.g., releasing a base in an acidic environment). The trigger mechanism 80 can include creating sacrificial sinks for the chemical species to attack (e.g., by placing a more reactive element in close proximity to the substrate 10). Degradation of this sacrificial element would then reduce the concentration of the chemical species available to degrade the substrate 10. If the degradation of the substrate 10 is electrochemically driven, the same effect could be achieved, for example, by placing a sacrificial anode (more negative electrochemical potential than substrate) in proximity to and in electrical contact with the substrate 10.

In some embodiments, the liquid impregnated surface 60 can be “surrounded” by a membrane configured to retain excess liquid around the substrate. The membrane can permeable to chemical species in the environment, but impermeable to the impregnating liquid.

In some embodiments, releasing and/or dispensing impregnating liquid into target environment (e.g., even small quantities of the impregnating liquid) with higher density than the target environment, can resupply the substrate if the substrate is positioned in proximity to the lowest point of its environment.

In some embodiments, the substrate can be substantially surrounded by a layer of gel which contains the impregnating liquid or a layer of porous material, such as a sponge, which contains the impregnating liquid and slowly releases the impregnating liquid to resupply the liquid-impregnated surface.

In some embodiments, the liquid can be emulsified in the environment and thus resupply the liquid impregnated surface 60 when in contact with the environment. For example, the liquid can be emulsified into fracking fluids for use of these barrier coatings in the oil and gas industry. Other examples of liquid resupply mechanisms are described in the '975 publication incorporated by reference above.

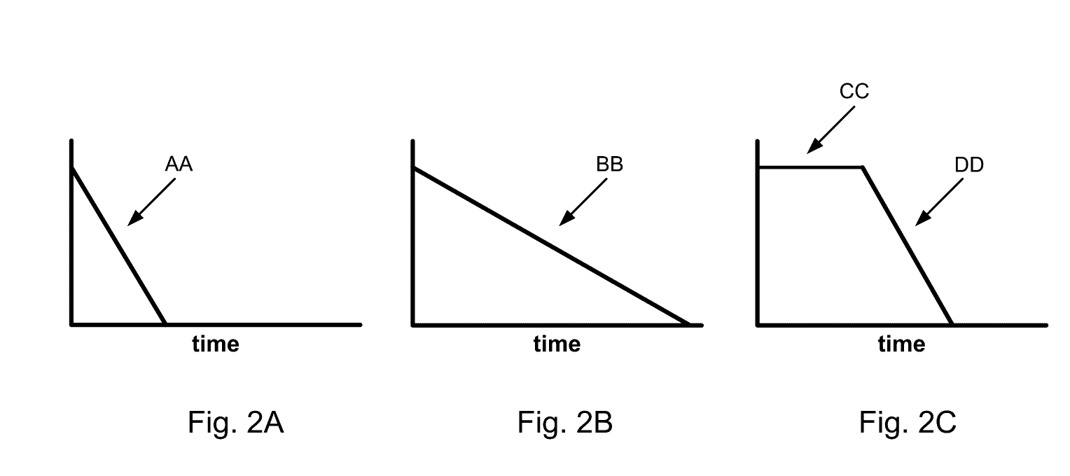

FIGS. 2A-2C show exemplary degradation profiles of a degradable material that illustrates the use of a barrier 20 and a triggering mechanism 80 to control and/or modify the degradation behavior of a degradable substrate 10. In the figures, the mass of the degradable material is plotted as a function of time, with the vertical axis showing the total mass of the substrate 10 (and a barrier 20 if present) and the horizontal axis showing the time when the mass is measured.

FIG. 2A shows an exemplary degradation profile without any modification to the substrate 10. In other words, FIG. 2A illustrates the degradation of a substrate that includes a degradable material without any type of barrier. Although the degradation profile AA is shown as a linear reduction of mass over time, the degradation profile can take any shape or form, including but not limited to a linear, logarithmic or exponential decaying profile.

FIG. 2B shows an exemplary degradation profile of a degradable substrate 10 with an addition of a barrier 20. In this graph, the degradation profile BB is also shown as a simple linear reduction of mass over time, but with a slower degradation profile to highlight the reduced rate of degradation compared to the degradation profile AA. In this case, the barrier 20 essentially prolongs the reduction of degradation. Alternatively, the modified degradation profile BB can show a “steeper” profile that illustrates an accelerated rate of degradation. In general, the type and range of modification by addition of a barrier 20 can take any shape or form, including but not limited to a linear, logarithm or exponential decaying profile.

FIG. 2C shows an exemplary degradation profile of the degradable substrate 10 with the addition of a barrier 20. The first segment CC denotes a “delay” to degradation afforded by the addition of the barrier 20. This modified profile CC shows little to no degradation of the degradable material 10 until the onset of degradation until a certain time. For example, the substrate can be “protected” by a barrier 20 and after the barrier 20 itself degrades or is otherwise compromised, the substrate degrades at substantially the same rate DD as shown in FIG. 2A. Alternatively, the degradation of the substrate in shown in FIG. 2C can be initiated by the trigger mechanism 80. In this example, the trigger mechanism 80 initiates the degradation at the inflection point between CC and the second segment DD to suddenly increase the degradation rate. The combined profile of CC and DD illustrate a general use of an added trigger mechanism 80 to “initiate” the onset of degradation to a later time until when the degradation can be postponed to follow a different degradation profile.

Although shown in FIG. 2B as being a reduced rate of degradation, and in FIG. 2C as being a delayed degradation, any combination of the aforementioned degradation profile modifications is possible with the barrier 20 and optional trigger mechanism 80. In other words, the barrier 20 can be tailored to customize the degradation profile according to any desired application. For example, the barrier 20 can be configured to both delay the onset of degradation, and reduce the rate of degradation once the substrate begins to degrade.

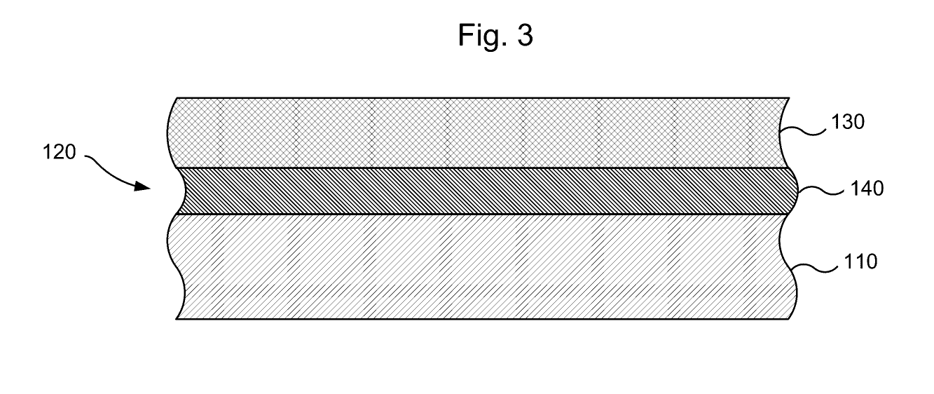

FIG. 3 is a schematic illustration of a system for controlling the degradation profile of a degradable material using a single conformal coating. In this embodiment, the system includes a degradable substrate 110 and a barrier 120 that includes a conformal coating 140 configured to protect the substrate 110 from a target environment 130. Optionally, a trigger mechanism (not shown) can be used to further control and/or modify the degradation behavior of the substrate 110.

As described herein, the substrate 110 can include one or more degradable materials, including those designed to specifically disintegrate, dissolve or fragment under well-defined conditions within a certain period of time. The substrate 110 can be formed entirely or partially from degradable materials, and can be homogeneous, heterogeneous and/or porous. Examples of degradable materials include inorganic-based metals, metal alloys, ceramics, synthetic organic-based plastics, and polymers. The substrate 110 can be substantially similar to the substrate 10, described above in reference to FIG. 1. Therefore, the substrate 110 is not described in further detail herein and should be considered substantially similar unless explicitly described differently.

As described herein, the barrier 120 includes a conformal coating 140, but not a liquid impregnated surface. The conformal coating 140 can be substantially similar to the conformal coating 40, described above in reference to FIG. 1. Therefore, the conformal coating 140 is not described in further detail herein and should be considered substantially similar unless explicitly described differently. Some embodiments of specific functionalities and benefits of the conformal coating 140 in response to its target environment 130 are described hereafter.

In some embodiments, the conformal coating 140 can include a chemically active species that is released into the environment 130. The type and concentration of the chemically active species in the conformal coating 140 can be used to accelerate or decelerate (e.g. release more or less catalyst or inhibitor for substrate degradation reaction) the degradation of the substrate 110.

In some embodiments, the degradation of the substrate 110 can be initiated and sustained by contact with a chemical species in the target environment 130. This exposure can be controlled by adjusting the fraction of the surface area of the substrate 110 which is in direct contact to the environment 130 and/or by controlling the rate at which the chemical species in the environment 130 arrive at the surface of the substrate 110. In some embodiments, the conformal coating 140 can be selected based on its selective permeability for a specific chemical species. For example, the conformal coating 140 can be permeable for the reactants that are required for the degradation of the substrate 110, but not for the reaction products. This selective permeability can be used to shift the reaction balance between reactants and products.

This paragraph should include all the other mechanisms that allow to tune the lifetime of the coating/substrate.

The solid can contain chemically active species which are released into the environment. By adjusting the variety and content of these chemically active species in the solid coating the degradation of the substrate can be accelerated or decelerated. (e.g. release more or less catalyst or inhibitor for substrate degradation reaction)

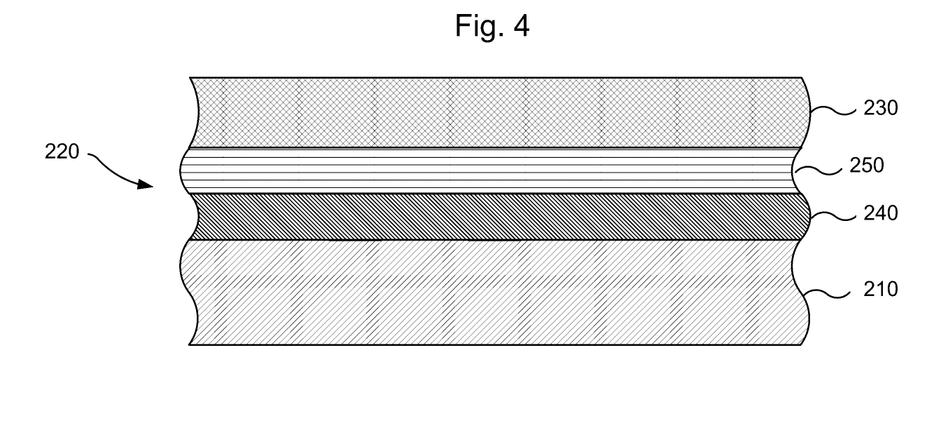

FIG. 4 is a schematic illustration of a system for controlling the degradation profile of a degradable material using two conformal coatings. In this embodiment, the system includes a degradable substrate 210 and a barrier 220 that includes a first conformal coating 240 and a second conformal coating 250 configured to protect the substrate 210 from a target environment 230. Optionally, a trigger mechanism (not shown) can be used to further control and/or modify the degradation behavior of the substrate 210.

As described herein, the substrate 210 can include one or more degradable materials, including those designed to specifically disintegrate, dissolve or fragment under well-defined conditions within a certain period of time. The substrate 210 can be formed entirely or partially from degradable materials, and can be homogeneous, heterogeneous and/or porous. Examples of degradable materials include inorganic-based metals, metal alloys, ceramics, synthetic organic-based plastics, and polymers. The substrate 210 can be substantially similar to the substrate 10, described above in reference to FIG. 1. Therefore, the substrate 210 is not described in further detail herein and should be considered substantially similar unless explicitly described differently.

As shown, the barrier 220 includes two conformal coatings 240 and 250, but does not include a liquid impregnated surface. However, a liquid impregnated surface can be included in the barrier 220 along with the first 240 and second conformal coating 250. The included conformal coatings 240 and 250 can be substantially similar to the conformal coating 40, described above in reference to FIG. 1. Therefore, the conformal coatings 240 and 250 are not described in further detail herein and should be considered substantially similar unless explicitly described differently.

In some embodiments, the combination of the two conformal coatings 240 and 250 result in a combined permeability of both layers with an overall permeability that effectively controls the degradation rate of the substrate 210. In addition, the second conformal coating 250 can supplement the first conformal coating 240 with added functionalities by including coating materials such as, for example, hydrogels, organogels, aerogels, ceramic epoxy resins, silicon dioxide, titanium dioxide and any organic-inorganic hybrid materials suitable as a coating layer for added protection, including but not limited to chemical resistance, corrosion resistance, mechanical degradation resistance, and various structural and chemical protections. Some embodiments of specific functionalities and benefits of having two conformal coatings 240 and 250 in response to its target environment 230 are described hereafter.

In some embodiments, the conformal coating 240 that is directly bonded to the substrate 210 can serve as a chemical protection layer that modifies the degradation profile while the conformal coating 250 can serve as a pure mechanical protection layer that prevents the underlying conformal coating 240 and the substrate 210 from getting scratched, dented, punctured or otherwise damaged prior to exposure to the target environment 230.

In some embodiments, the conformal coating 240 that is directly bonded to the substrate 210 can serve as a chemical protection layer that modifies the degradation profile and the conformal coating 250 can also serve as another chemical protection layer that augments the strength of protection to the conformal coating 240 with added chemical and structural protective functionalities to the underlying conformal coating 240 and the substrate 210. In this embodiment, the conformal coatings 240 and 250 can be each tailored specifically for a specific chemical species that are present in the target environment 230. By adjusting the variety and content of these chemically active species in the conformal coatings 240 and 250, the degradation behavior of the substrate 210, for example, can be modified to accelerate, prolong, delay or decelerate.

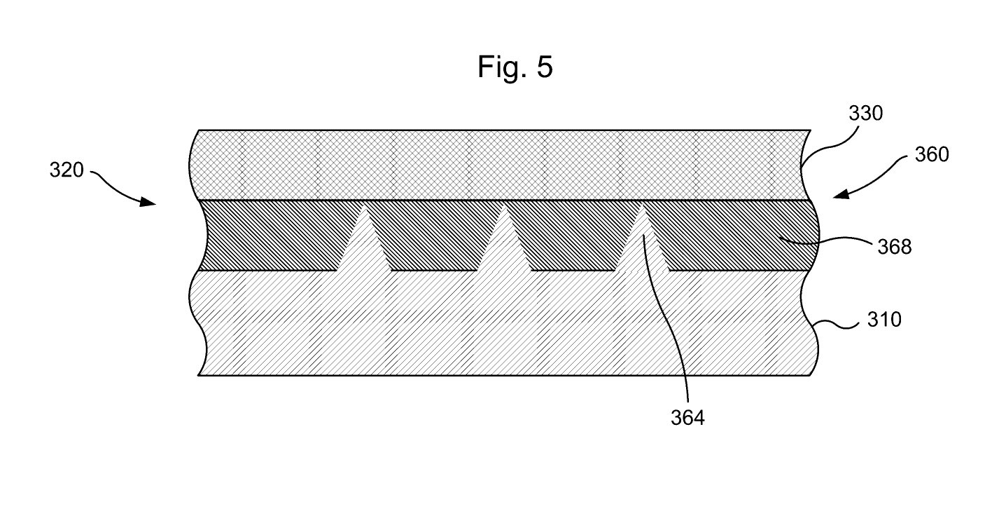

FIG. 5 is a schematic illustration of a system for controlling the degradation profile of a degradable material using a liquid impregnated surface. In this embodiment, the system includes a degradable substrate 310 and a barrier 320 that includes a liquid impregnated surface 360 configured to protect the substrate 310 from a target environment 330. The liquid impregnated surface 360 has two components, a matrix of solid features 364 and a wetting liquid 368. Optionally, a trigger mechanism (not shown) can be used to further control and/or modify the degradation behavior of the substrate 310.

As described herein, the substrate 310 can include one or more degradable materials, including those designed to specifically disintegrate, dissolve or fragment under well-defined conditions within a certain period of time. The substrate 310 can be formed entirely or partially from degradable materials, and can be homogeneous, heterogeneous and/or porous. Examples of degradable materials include inorganic-based metals, metal alloys, ceramics, synthetic organic-based plastics, and polymers. The substrate 310 can be substantially similar to the substrate 10, described above in reference to FIG. 1. Therefore, the substrate 310 is not described in further detail herein and should be considered substantially similar unless explicitly described differently.

As described herein, the barrier 320 includes a liquid impregnated surface 360, but not a conformal coating. The included liquid impregnated surface 360 can be substantially similar to the liquid impregnated surface 60, described above in reference to FIG. 1. Therefore, the liquid impregnated surface 360 is not described in further detail herein and should be considered substantially similar unless explicitly described differently. Some embodiments of specific functionalities and benefits of the liquid impregnated surface 360, including the matrix of solid features 364 and the liquid 368 in response to its target environment 330 are described hereafter.

In some embodiments, a matrix of solid features 364 can be created by any one or a combination of the following methods, including but not limited to any form of mechanical abrasion, such as polishing, sandblasting, rubbing with sandpaper, dry ice blasting, as well as machining techniques, such as milling, drilling, filing, cutting, high pressure cutting/machining, such as with a water-jet, laser cutting, laser rastering, dry etching, such as plasma etching, reactive ion etching, deep reactive ion etching, sputter etching, ion milling, and vapor phase etching, wet etching, such as exposure to acid or base solutions, exposure to ionic liquids and boiling in solvents, anodization, electrodissolution, stamping or embossing, and by common manufacturing processes of the substrate 310, such as casting or sintering (powder sintering), corona etching, heat treatment, flame treatment, plasma treatment, and irradiation, and all of the above techniques in combination with lithographic techniques that result in selective exposure of parts of the substrate to the above texture creation methods. In another embodiment, the matrix of solid features is inherent to the substrate.

In some embodiments, the impregnating liquid 368 can be applied by any system and method including, but not limited to, the systems and methods described in the '704 patent and the '611 publication incorporated by reference above. In some embodiments, the impregnating liquid 368 can have a higher viscosity (up to 1000 PaS) than the liquids described in the '704 patent and the '611 publication. In some embodiments, the liquid impregnated surface 360 meets the environmental, health and safety requirements of the target environment 330 in which the substrate 310 is deployed. In some embodiments, the impregnating liquid 368 of the liquid impregnated surface 360 can have a sufficiently low contact angle on the substrate 310 such that the liquid 368 “re-wet” the substrate 310 in places where the liquid impregnated surface 360 has been damaged due to, for instance mechanical abrasion (e.g. the liquid-impregnated surface 360 is self-healing).

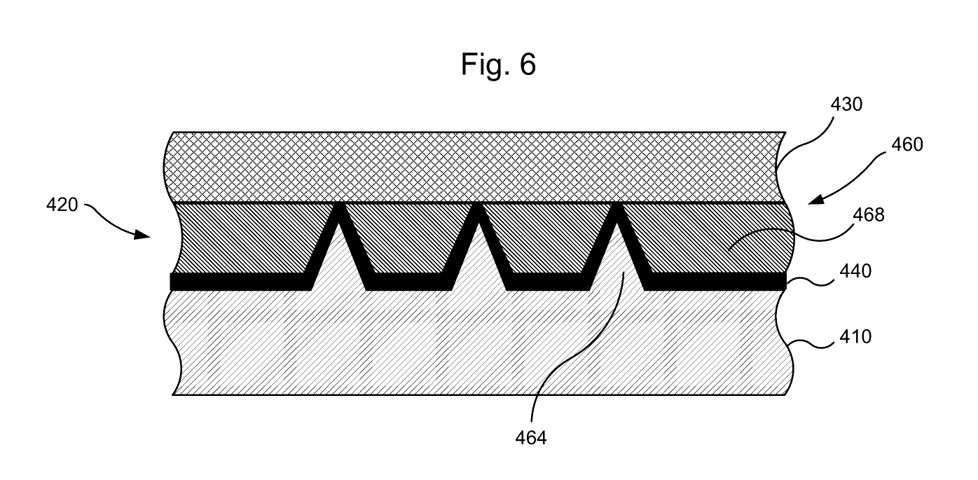

FIG. 6 is a schematic illustration of a system for controlling the degradation profile of a degradable material using a conformal coating in conjunction with a liquid impregnated surface. In this embodiment, the system includes a degradable substrate 410 and a barrier 420 that includes a conformal coating 440 and a liquid impregnated surface 460 configured to protect the substrate 410 from a target environment 430. The liquid impregnated surface 460 has two components, a matrix of solid features 464 and a wetting liquid 468. Optionally, a trigger mechanism (not shown) can be used to further control and/or modify the degradation behavior of the substrate 410.

As described herein, the substrate 410 can include one or more degradable materials, including those designed to specifically disintegrate, dissolve or fragment under well-defined conditions within a certain period of time. The substrate 410 can be formed entirely or partially from degradable materials, and can be homogeneous, heterogeneous and/or porous. Examples of degradable materials include inorganic-based metals, metal alloys, ceramics, synthetic organic-based plastics, and polymers. The substrate 410 can be substantially similar to the substrate 10, described above in reference to FIG. 1. Therefore, the substrate 410 is not described in further detail herein and should be considered substantially similar unless explicitly described differently.

As described herein, the barrier 420 includes the conformal coating 440 and the liquid impregnated surface 460. The included conformal coating 440 can be substantially similar to the conformal coating 140, described above in reference to FIG. 3. Therefore, the conformal coating 440 is not described in further detail herein and should be considered substantially similar unless explicitly described differently. Similarly, the liquid impregnated surface 460 can be substantially similar to the liquid impregnated surface 360, described above in reference to FIG. 5. Therefore, the liquid impregnated surface 460 is not described in further detail herein and should be considered substantially similar unless explicitly described differently. Some embodiments of specific functionalities and benefits of the conformal coating 440 and the liquid impregnated surface 460, including the matrix of solid features 464 and the liquid 468 in response to its target environment 430 are described hereafter.

In some embodiments, the conformal coating 440 can be substantially similar to the specific embodiments of the conformal coating 140, described above in reference to FIG. 3. Therefore, the conformal coating 440 is not described in further detail herein and should be considered substantially similar unless explicitly described differently.

In some embodiments, the conformal coating 440 that is directly bonded to the matrix of solid features 464 of the substrate 410 to serve as a function such as, for example a chemical modifier or adhesion layer that can add augmented control and modification to the degradation profile of the underlying textured surface the substrate 410. In this embodiment, the conformal coating 440 and the matrix of solid features 464 of the liquid impregnated surface 460 can be each tailored specifically for a function in response to the target environment 430. By adjusting the properties in the conformal coating 440 and the liquid impregnate surface 460, the degradation behavior of the substrate 410, for example, can be modified to accelerate, prolong, delay or decelerate.

In some embodiments, the matrix of solid features 464 of the liquid impregnated surface 460 can be created by the methods described above in reference to FIG. 5. Therefore, the method of preparation of the matrix of solid features 464 is not described in further detail herein and should be considered substantially similar unless explicitly described differently.

In some embodiments, the impregnating liquid 468 of the liquid impregnated surface 460 can be substantially similar to the wetting liquid 368 of the liquid impregnated surface 360, described above in reference to FIG. 5. Therefore, the liquid 468 of liquid impregnated surface 460 is not described in further detail herein and should be considered substantially similar unless explicitly described differently.

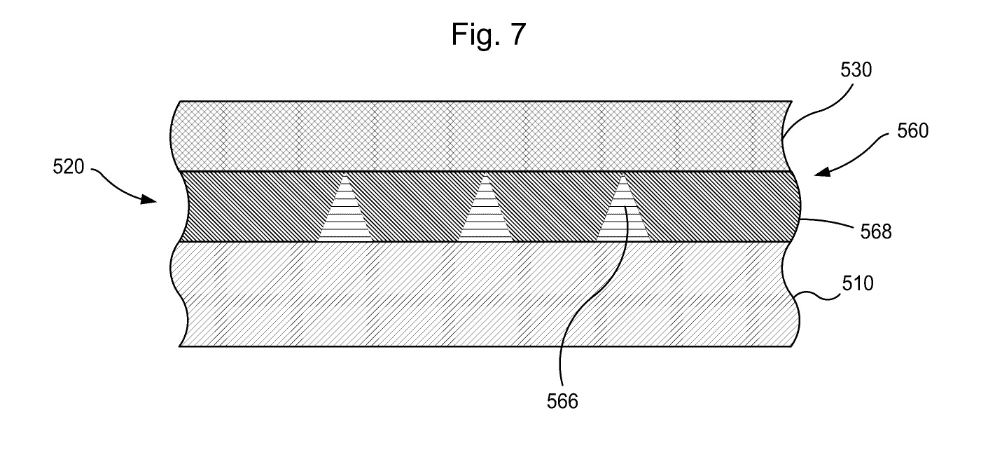

FIG. 7 is a schematic illustration of a system for controlling the degradation profile of a degradable material using a liquid impregnated surface. In this embodiment, the system includes a degradable substrate 510 and a barrier 520 that includes a liquid impregnated surface 560 configured to protect the substrate 510 from a target environment 530. The liquid impregnated surface 560 has two components, a matrix of solid features 566 and a wetting liquid 568. Optionally, a trigger mechanism (not shown) can be used to further control and/or modify the degradation behavior of the substrate 510.

As described herein, the substrate 510 can include one or more degradable materials, including those designed to specifically disintegrate, dissolve or fragment under well-defined conditions within a certain period of time. The substrate 510 can be formed entirely or partially from degradable materials, and can be homogeneous, heterogeneous and/or porous. Examples of degradable materials include inorganic-based metals, metal alloys, ceramics, synthetic organic-based plastics, and polymers. The substrate 510 can be substantially similar to the substrate 10, described above in reference to FIG. 1. Therefore, the substrate 510 is not described in further detail herein and should be considered substantially similar unless explicitly described differently.

As described herein, the barrier 520 includes a liquid impregnated surface 560, but not a conformal coating. The included liquid impregnated surface 560 can be substantially similar to the liquid impregnated surface 360, described above in reference to FIG. 5. Therefore, the liquid impregnated surface 560 is not described in further detail herein and should be considered substantially similar unless explicitly described differently. Some embodiments of specific functionalities and benefits of the liquid impregnated surface 560, including the matrix of solid features 566 and the liquid 568 in response to its target environment 530 are described hereafter.

In some embodiments, a matrix of solid features 566 of the liquid impregnated surface 560 can be analogous to the matrix of solid features 364 of the liquid impregnated surface 360, described above in reference to FIG. 5. Instead of modifying the existing surface of the underlying substrate 310 to create “texture,” the matrix of solid features 364 as described in FIG. 5, the matrix of solid features 566 are added to the surface of substrate 510 to create the “texture” of the liquid impregnated surface 560.

In some embodiments, the matrix of solid features 566 can also be made up of the conformal coating 40 which has been texturized with the subtractive methods described in herein.

In some embodiments, the impregnating liquid 568 of the liquid impregnated surface 560 can be substantially similar to the wetting liquid 368 of the liquid impregnated surface 360, described above in reference to FIG. 5. Therefore, the liquid 568 of liquid impregnated surface 560 is not described in further detail herein and should be considered substantially similar unless explicitly described differently.

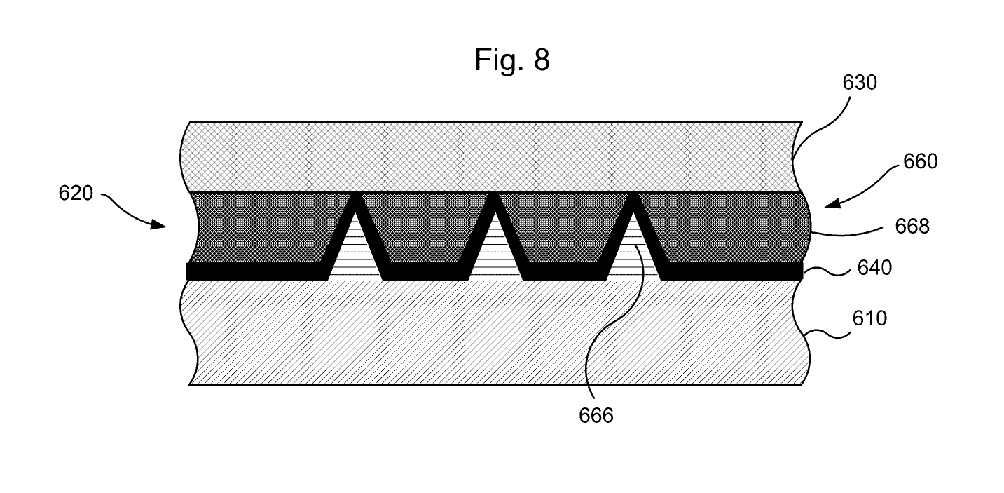

FIG. 8 is a schematic illustration of a system for controlling the degradation profile of a degradable material using a conformal coating in conjunction with a liquid impregnated surface. In this embodiment, the system includes a degradable substrate 610 and a barrier 620 that includes a conformal coating 640 and a liquid impregnated surface 660 configured to protect the substrate 610 from a target environment 630. The liquid impregnated surface 660 has two components, a matrix of solid features 666 and a wetting liquid 668. Optionally, a trigger mechanism (not shown) can be used to further control and/or modify the degradation behavior of the substrate 610.

As described herein, the substrate 610 can include one or more degradable materials, including those designed to specifically disintegrate, dissolve or fragment under well-defined conditions within a certain period of time. The substrate 610 can be formed entirely or partially from degradable materials, and can be homogeneous, heterogeneous and/or porous. Examples of degradable materials include inorganic-based metals, metal alloys, ceramics, synthetic organic-based plastics, and polymers. The substrate 610 can be substantially similar to the substrate 10, described above in reference to FIG. 1. Therefore, the substrate 610 is not described in further detail herein and should be considered substantially similar unless explicitly described differently.

As described herein, the barrier 620 includes the conformal coating 640 and the liquid impregnated surface 660. The included conformal coating 640 can be substantially similar to the conformal coating 440, described above in reference to FIG. 6. Therefore, the conformal coating 640 is not described in further detail herein and should be considered substantially similar unless explicitly described differently. Similarly, the liquid impregnated surface 660 can be substantially similar to the liquid impregnated surface 360, described above in reference to FIG. 5. Therefore, the liquid impregnated surface 660 is not described in further detail herein and should be considered substantially similar unless explicitly described differently. Some embodiments of specific functionalities and benefits of the conformal coating 640 and the liquid impregnated surface 660, including the matrix of solid features 666 and the liquid 668 in response to its target environment 630 are described hereafter.

In some embodiments, the matrix of solid features 666 of the liquid impregnated surface 660 can be analogous to the matrix of solid features 566 of the liquid impregnated surface 560, described above in reference to FIG. 7. Therefore, the method of preparation and the materials of the matrix of solid features 666 are not described in further detail herein and should be considered substantially similar unless explicitly described differently.

In some embodiments, the impregnating liquid 668 of the liquid impregnated surface 660 can be substantially similar to the wetting liquid 468 of the liquid impregnated surface 460, described above in reference to FIG. 6. Therefore, the liquid 668 of liquid impregnated surface 660 is not described in further detail herein and should be considered substantially similar unless explicitly described differently.

In some embodiments, the conformal coating 640 can be substantially similar to the specific embodiments of the conformal coating 440, described above in reference to FIG. 6. Therefore, the conformal coating 640 is not described in further detail herein and should be considered substantially similar unless explicitly described differently.

In some embodiments, the arrangement of the barrier 620 can be substantially similar to the layer arrangement embodied in the barrier 420 described in FIG. 6, except for the technique and the materials used for creating the texture. In FIG. 6, the matrix of solid features 464 is created by chemical and mechanical modification to the underlying surface of the substrate 410, where as in FIG. 8, the matrix of solid features 666 is created by addition of materials onto the substrate 610.

In some embodiments, the combination of the conformal coating 640 and the liquid impregnated surface 660 provide a more complex set of tools to control and modify the degradation profile of the substrate 610. With these layers, the barrier 620 can be fine-tuned to provide a more complete augmented control and modification to the degradation profile of the underlying textured surface the substrate 610. For example, by adjusting the properties of the conformal coating 640 and the liquid impregnated surface 660, the degradation behavior of the substrate 610 can be modified dynamically to accelerate, prolong, delay or decelerate according to the set of conditions in the target environment 630.

### Examples

Experiments were performed on commercially available sugar cubes, which readily dissolve in de-ionized water and lose their structural integrity. Due to their granular nature, the sugar cubes exhibit inherent porosity and surface roughness, and thus provide a suitable solid texture for a liquid-impregnated surface.

Three different sample types were investigated: (a) uncoated sugar cubes, (b) sugar cubes coated with a conformal solid, and (c) sugar cubes coated with a conformal solid as (b) and with an impregnating liquid to form a liquid impregnated surface. The uncoated sugar cubes in all three examples had an initial mass of about 2.0 g. The mass of the conformal solid coating in examples (b) and (c) was about 0.2 g and the mass of the impregnating liquid was about 1.0 g. Therefore, the total initial mass of the sugar cube in example (a) was about 2.0 g, the total initial mass of the sugar cube with the conformal solid coating in example (b) was about 2.2 g, and the total initial mass of the sugar cube with the conformal solid coating and the impregnating liquid in example (c) was about 3.2 g.

The coated (i.e., examples (b) and (c)) and uncoated (i.e., example (a)) sugar cubes were immersed in de-ionized water and their change in mass was measured as a function of time. In a first experiment, the de-ionized water was held at room temperature (RT), and in a second experiment, the de-ionized water was held at 90° C. At each measurement point, the sugar cubes were removed from the water bath and dried in an oven at 50° C. for 20 minutes to remove excess water.

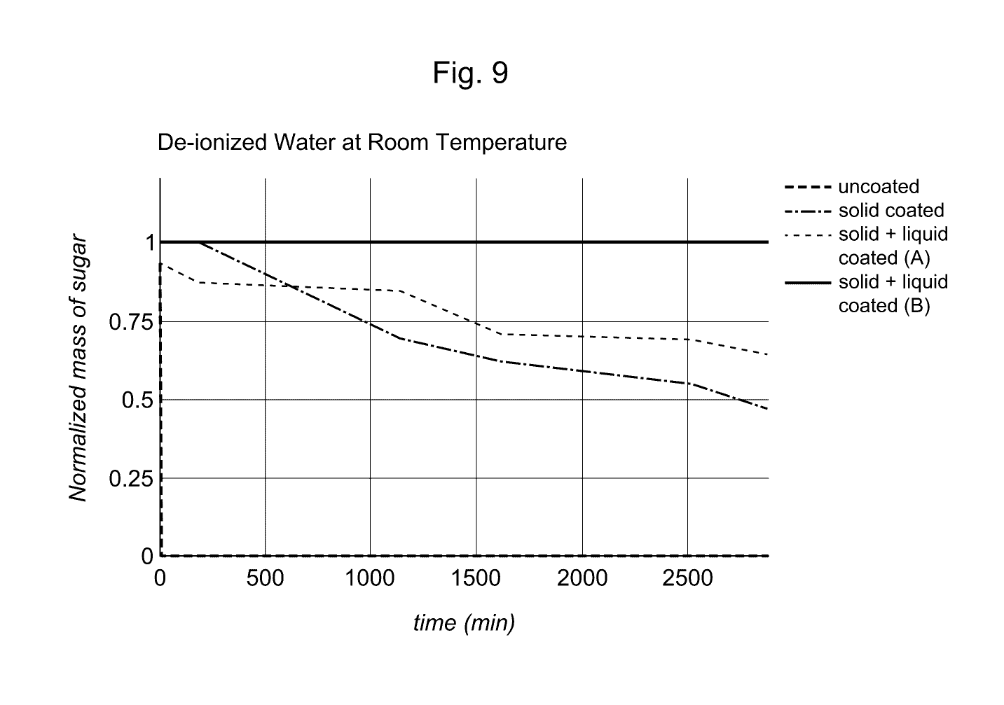

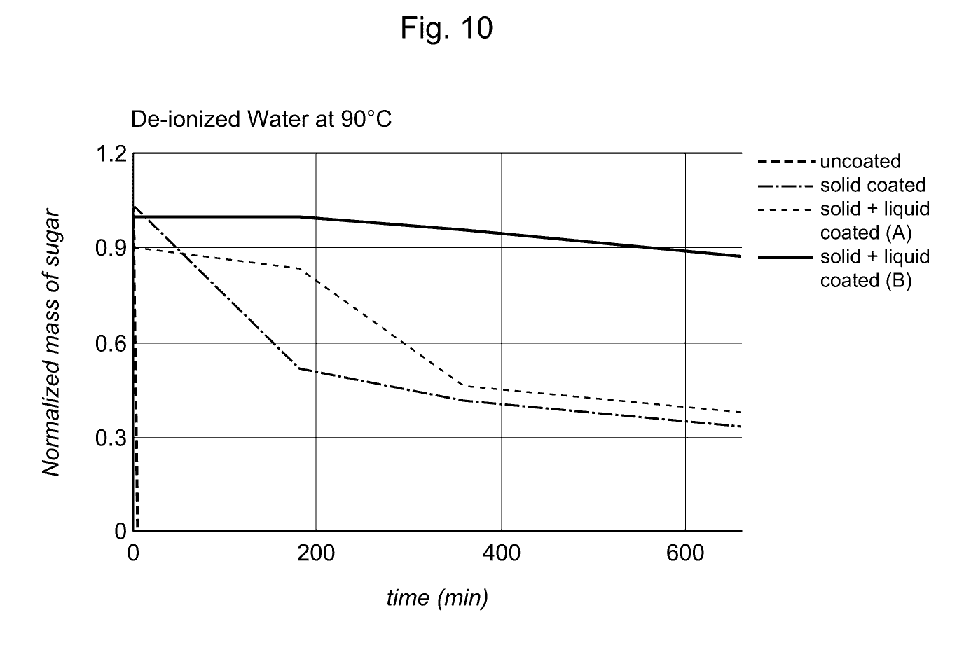

FIG. 9 and FIG. 10 show the time evolution of the mass of each of the sugar cubes normalized to its initial mass. For the samples coated with the conformal solid coating, it was assumed that none of the solid coating was dissolved during the experiments and thus the remaining sugar mass was calculated as the difference between the total mass weighed at each time and the mass of the coating (i.e., about 0.2 g). The same assumption was used for the samples coated with the conformal solid and the impregnating liquid with respect to the conformal solid coating. However, in the examples where the samples were coated with an impregnating liquid, it is believed that weight loss can occur through two mechanisms—dissolution of sugar and/or drainage of the impregnating liquid. In order to establish a lower bound on the amount of sugar remaining over time, it was assumed that all of the mass loss was due to the sugar and none of the liquid was removed (see solid plus liquid (A) line in FIGS. 9 and 10). Thus, the remaining sugar mass is the difference between the weighed mass at each time point and the sum of the mass of the solid coating (i.e., about 0.2 g) and the liquid (i.e., about 1.0 g). In order to establish a higher bound on the amount of sugar remaining over time, it was assumed that all of the liquid drained and only the remainder of the mass loss was due to dissolution of sugar (see solid plus liquid (B) line in FIGS. 9 and 10). Thus, the remaining sugar mass is the difference between the weighed mass at each time point and the mass of the solid coating (i.e., about 0.2 g). In all cases, the values derived from these assumptions were limited to a maximum value corresponding to the initial weight of the uncoated sugar cube.

As shown in FIG. 9, in the RT experiment the uncoated sugar cubes dissolve and lose their structural integrity within 30 minutes. In contrast, the sugar cubes coated with the conformal solid coating lost only 53% of their mass within 48 h. The sugar cubes coated with the conformal solid and the impregnating liquid degrade even slower. Assuming that after 48 h the sugar cubes still contain all the impregnating liquid (i.e. no drainage), 36% of the sugar dissolves within 48 h. In contrast, if the sugar cubes do not contain any impregnating liquid after 48 h (i.e. complete drainage) then none of the sugar has dissolved, as all of the mass loss would then be attributed to the loss of impregnating liquid. In both cases, the degradation is slower than for the conformal solid coating alone.

As shown in FIG. 10, the experiment conducted at 90° C. exhibits similar behavior. The uncoated sugar cubes lose their structural integrity within 30 s. In contrast, the sugar cubes coated with the conformal solid coating lose only 66% of their initial mass within 11 h. The sugar cubes coated with the conformal solid and the impregnating liquid degrade even slower. Assuming that after 11 h the sugar cubes still contain all the impregnating liquid (i.e. no drainage), 62% of the sugar has dissolved. In contrast, if the sugar cubes do not contain any impregnating liquid after 11 h (i.e. complete drainage), then only 13% of the sugar has dissolved. In both cases, the degradation is slower than for the conformal solid coating alone.

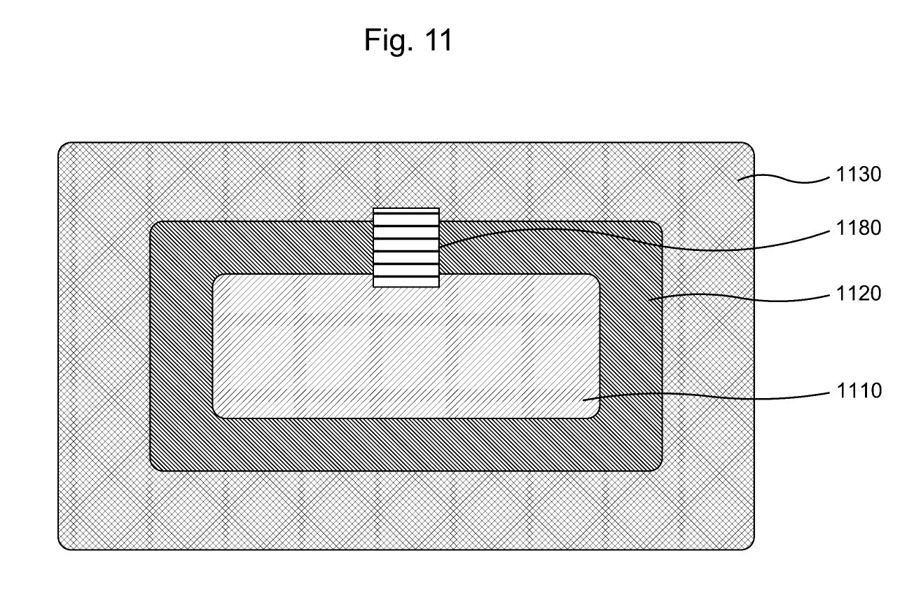

FIG. 11 is a schematic illustration of a substrate protected by a barrier implemented with a trigger mechanism that can be used to initiate the degradation behavior of the barrier/substrate system in a target environment. The system includes a degradable substrate 1110, a barrier 1120 configured to protect the substrate 1110 from a target environment 1130, and a trigger mechanism 1180 configured to initiate, control, and/or modify the degradation behavior of the substrate 1110.

As described herein, the substrate 1110 can include one or more degradable materials, including those designed to specifically disintegrate, dissolve or fragment under well-defined conditions within a certain period of time. The substrate 1110 can be substantially similar to the substrate 10, described above in reference to FIG. 1. Therefore, the substrate 1110 is not described in further detail herein and should be considered substantially similar unless explicitly described differently.

As described herein, the barrier 1120 can include a conformal coating and/or a liquid impregnated surface. The barrier 1120 can be substantially similar to the barrier 20, described above in reference to FIG. 1. Therefore, the barrier 1120 is not described in further detail herein and should be considered substantially similar unless explicitly described differently. In some embodiments, the degradation of the substrate 1110 can be initiated and sustained by contact with a chemical species in the target environment 1130. This exposure can be controlled by adjusting the surface area of the substrate 1110 which is in direct contact with the target environment 1130 and/or by controlling the rate at which the chemical species in the target environment 1130 arrive at the surface of the substrate 1110.

In some embodiments, the trigger mechanism 1180 can be in the form of a fuse that extends from the substrate 1110, through the barrier 1120, and to the environment 1130. The trigger mechanism 1180 (also referred to herein as “fuse 1180”) can be at least partially uncoated to allow for exposure to the target environment 1130. In some embodiments, the trigger mechanism 1180 can be disposed on the substrate 1110 and/or inserted into the substrate 1110 and then the substrate 1110 can be coated with the barrier 1120, or the fuse could be a protrusion of the substrate material 1110. The barrier 1120 can then be selectively removed from parts of the trigger mechanism 1180, exposing certain areas to the environment 1130. For example, portions of the trigger mechanism 1180 can be exposed by mechanical abrasion of the barrier 1120, by cutting or shearing a portion of the barrier 1120 and fuse 1180, by cutting through the barrier 1120, and/or by chemical etching to expose uncoated surface. In some embodiments, the barrier 1120 can be prevented from adhering to a portion of the trigger mechanism 1180 during deposition of the protective barrier 1120. For example, this can be accomplished by masking off part of the trigger mechanism 1180, coating the entire part, and then removing the mask. In some embodiments, the substrate 1110 can be coated with the barrier 1120, and then the trigger mechanism 1180 can be inserted into the substrate 1110 through the barrier 1120.

As described herein, the trigger mechanism 1180 can be any geometry and shape, including a rod, a tube, a block, a sphere, and/or any other possible shape or combinations thereof. The trigger mechanism 1180 can include any material that can be degraded, decomposed, or melted in an environment, including, but not limited to, brine solutions, acidic solutions (such as, those containing hydrochloric acid, sulfuric acid, hydrofluoric acid, phosphoric acid, or inhibited variants of any of these acids, or combinations thereof), caustic solutions (such as, aqueous solutions of sodium hydroxide, potassium hydroxide, or others), or chemical solvents (such as, acetone, isopropanol, benzene, toluene, methanol, ethanol, xylene, tetrahydrofuran, or others). The trigger mechanism 1180 can include metals, such as magnesium, aluminum, calcium, germanium, zinc, manganese or alloys containing any combination thereof. The trigger mechanism 1180 can also include organic materials including polymers that decompose or dissolve in solutions, and water-soluble materials, such as polyesters (polylactic acid, polyglycolic acid, etc), polyhydroxy butyrates, polyvinyl acetates, polyvinyl alcohols, polyacrylic acids, polyethylene glycol polysaccharides, polyvinyl chlorides, acrylonitrile butadiene styrene (ABS), polystyrenes, or other materials. The surface of the trigger mechanism 1180 can be textured and/or coated in the same manner described of the degradable substrate 10 as described in FIG. 1, which may include surface preparation techniques, such as sandblasting, solvent cleaning, etc., which are substantially similar to those described previously with respect to FIG. 1 and FIG. 5. The fuse 1180 may be the same material as the substrate 1110.

By exposing the trigger mechanism 1180 to the target environment 1130 that degrades the trigger mechanism material, the chemical species in the environment solution will eventually come in contact with and begin to degrade the substrate 1110. Thus, exposing the trigger mechanism 1180 to the target environment 1130 will trigger the degradation of the entire part within a certain amount of time. Although the illustration in FIG. 11 shows one trigger mechanism 1180, a plurality of trigger mechanism 1180 can be used to modify the degradation rate of the substrate 1110 by increasing contact and surface exposure to the environment 1130. Similarly, the size of the trigger mechanism 1180 with respect to the substrate 1110 can be modified to modify the degradation rate of the substrate 1110.

In some embodiments, the trigger mechanism 1180 can include a degradable fuse material at least partially disposed inside a substrate, and the degradable fuse material can be formulated to dissolve at a first degradation rate when exposed to a first environment, and at a second degradation rate when exposed to a second environment. The second environment can include a trigger fluid formulated to transition dissolution of the degradable fuse material from the first degradation rate to the second degradation rate.

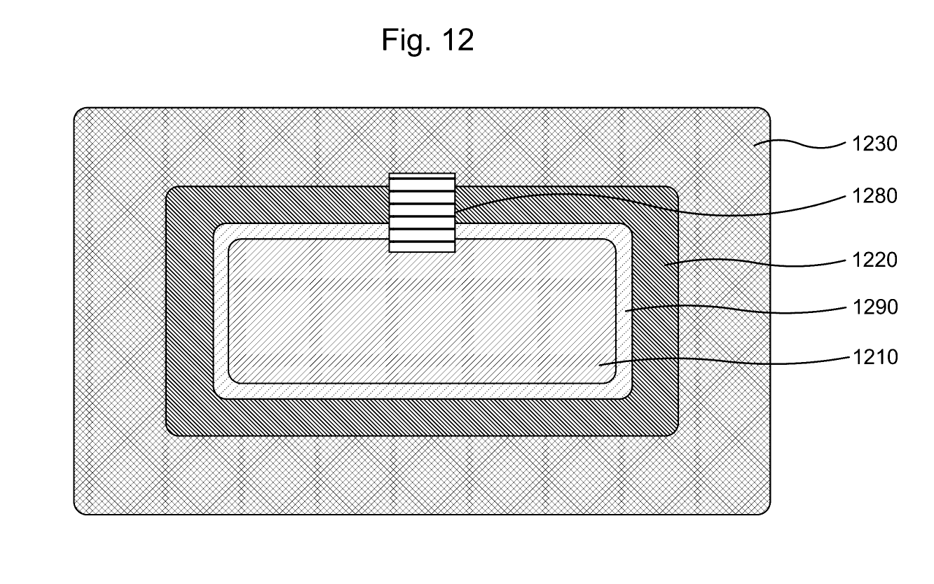

FIG. 12 is a schematic illustration of a substrate protected by a barrier implemented with a trigger mechanism that can be used to initiate the degradation behavior of the barrier/substrate system in a target environment. The system includes a degradable substrate 1210, a barrier 1220 configured to protect the substrate 1210 from a target environment 1230, and a trigger mechanism 1280 configured to initiate, control, and/or modify the degradation behavior of the substrate 1210.

As described herein, the substrate 1210 can include one or more degradable materials, including those designed to specifically disintegrate, dissolve or fragment under well-defined conditions within a certain period of time. The substrate 1210 can be substantially similar to the substrate 10, described above in reference to FIG. 1. Therefore, the substrate 1210 is not described in further detail herein and should be considered substantially similar unless explicitly described differently.

As described herein, the barrier 1220 can include a conformal coating and/or a liquid impregnated surface. The barrier 1220 can be substantially similar to the barrier 20, described above in reference to FIG. 1. Therefore, the barrier 1220 is not described in further detail herein and should be considered substantially similar unless explicitly described differently. In some embodiments, the degradation of the substrate 1210 can be initiated and sustained by contact with a chemical species in the target environment 1230. This exposure can be controlled by adjusting the surface area of the substrate 1210 which is in direct contact with the target environment 1230 and/or by controlling the rate at which the chemical species in the target environment 1230 arrive at the surface of the substrate 1210.

In some embodiments, the trigger mechanism 1280 can be in the form of a fuse that extends from the substrate 1210, through the barrier 1220, and to the environment 1230. The fuse 1280 can be substantially similar to the fuse 1180, described above in reference to FIG. 11. Therefore, the fuse 1280 is not described in further detail herein and should be considered substantially similar unless explicitly described differently. As shown in FIG. 12, a dissolvable material 1290 (also referred to herein as a “dissolvable layer”) is disposed between the substrate 1210 and the barrier 1220 and in contact with the trigger mechanism 1280. As the trigger mechanism 1280 begins to degrade in the environment 1230, the dissolvable material 1290 will also begin to degrade and the surface area of the substrate 1210 in contact with the environment 1230 will increase, thereby accelerating degradation of the substrate 1210. In other words, this will allow any chemicals present in the environment 1230 that are responsible for degradation of the substrate 1210 to begin degrading the substrate 1210 from virtually all directions/all surfaces. Although the illustration in FIG. 12 shows only one fuse 1280, a plurality of fuses 1280 may be used to modify the degradation rate of the substrate 1210 by increasing contact and surface exposure to the environment 1230.

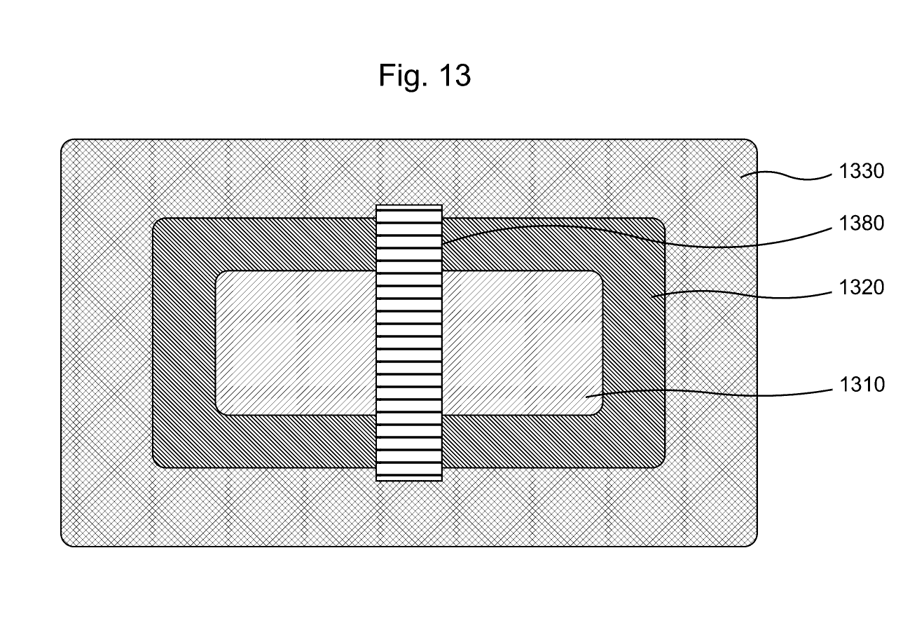

FIG. 13 is a schematic illustration of a substrate protected by a barrier implemented with a trigger mechanism that can be used to initiate the degradation behavior of the barrier/substrate system in a target environment. The system includes a degradable substrate 1310, a barrier 1320 configured to protect the substrate 1310 from a target environment 1330, and a trigger mechanism 1380 configured to initiate, control, and/or modify the degradation behavior of the substrate 1310.

As described herein, the substrate 1310 can include one or more degradable materials, including those designed to specifically disintegrate, dissolve or fragment under well-defined conditions within a certain period of time. The substrate 1310 can be substantially similar to the substrate 10, described above in reference to FIG. 1. Therefore, the substrate 1310 is not described in further detail herein and should be considered substantially similar unless explicitly described differently.

As described herein, the barrier 1320 can include a conformal coating and/or a liquid impregnated surface. The barrier 1320 can be substantially similar to the barrier 20, described above in reference to FIG. 1. Therefore, the barrier 1320 is not described in further detail herein and should be considered substantially similar unless explicitly described differently. In some embodiments, the degradation of the substrate 1310 can be initiated and sustained by contact with a chemical species in the target environment 1330. This exposure can be controlled by adjusting the surface area of the substrate 1310 which is in direct contact with the target environment 1330 and/or by controlling the rate at which the chemical species in the target environment 1330 arrive at the surface of the substrate 1310.

In some embodiments, the trigger mechanism 1380 can be in the form of a fuse that extends entirely through the substrate 1310. The trigger mechanism 1380 shown in FIG. 13 may have substantially similar materials and material properties as those detailed above in FIG. 11, and therefore will not be described in further detail. In this embodiment, the trigger mechanism 1380 extends the entire way through the bulk of the substrate 1310 to expose the trigger mechanism 1380 on both sides of the substrate 1310. Upon exposure to the target environment 1330, the trigger mechanism 1380 will begin to degrade in at least two locations, which allows the environment 1330 to begin degrading the substrate 1310 from within the inner bulk of the substrate 1310. Although the illustration in FIG. 13 shows only one trigger mechanism 1380 that extends through the substrate 1310, a plurality of trigger mechanisms 1380 may be used to modify the degradation rate of the substrate 1310 by increasing contact and surface exposure to the environment 1330.

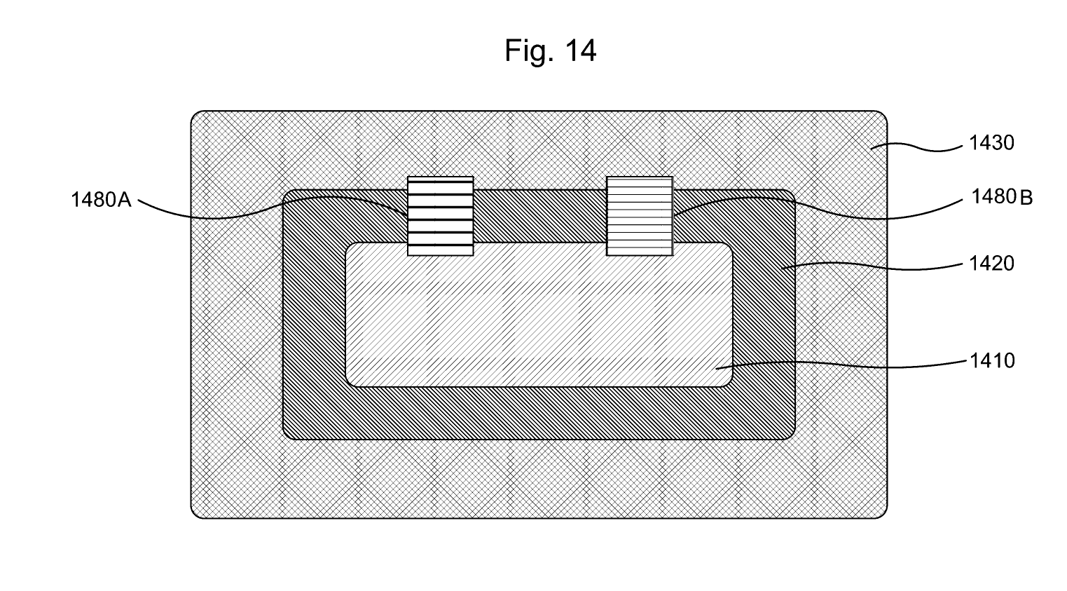

FIG. 14 is a schematic illustration of a substrate protected by a barrier implemented with a trigger mechanism that can be used to initiate the degradation behavior of the barrier/substrate system in a target environment. The system includes a degradable substrate 1410, a barrier 1420 configured to protect the substrate 1410 from a target environment 1430, a first trigger mechanism 1480A and a second trigger mechanism 1480B. The first trigger mechanism 1480A and the second trigger mechanism 1480B are either individually or collectively configured to initiate, control, and/or modify the degradation behavior of the substrate 1410.

As described herein, the substrate 1410 can include one or more degradable materials, including those designed to specifically disintegrate, dissolve or fragment under well-defined conditions within a certain period of time. The substrate 1410 can be substantially similar to the substrate 10, described above in reference to FIG. 1. Therefore, the substrate 1410 is not described in further detail herein and should be considered substantially similar unless explicitly described differently.

As described herein, the barrier 1420 can include a conformal coating and/or a liquid impregnated surface. The barrier 1420 can be substantially similar to the barrier 20, described above in reference to FIG. 1. Therefore, the barrier 1420 is not described in further detail herein and should be considered substantially similar unless explicitly described differently. In some embodiments, the degradation of the substrate 1410 can be initiated and sustained by contact with a chemical species in the target environment 1430. This exposure can be controlled by adjusting the surface area of the substrate 1410 which is in direct contact with the target environment 1430 and/or by controlling the rate at which the chemical species in the target environment 1430 arrive at the surface of the substrate 1410.

As described herein, in some embodiments, multiple trigger mechanisms 1480A and 1480B (collectively, “trigger mechanisms 1480”) can be used modify the degradation rate of the substrate 1410 by increasing contact and surface exposure to the environment 1430. In some embodiments, the first trigger mechanism 1480A and the second trigger mechanism 1480B can be made from different materials to allow more precise control of the degradation profile of the substrate 1410. For example, the degradation rate of the first trigger mechanism 1480A can be significantly slower than the degradation rate of the second trigger mechanism 1480B. In some embodiments, each of the trigger mechanisms 1480 can be configured to degrade substantially differently upon exposure to different target environments 1430, and thus the preferred degradation profile can be selected at an appropriate time for an appropriate target environment 1430. For example, the first trigger mechanism 1480A can be configured to degrade at a rate A when exposed to certain environments, but is substantially stable (i.e., does not degrade) when exposed to other environments. The second trigger mechanism 1480B can be configured to degrade at a rate B when exposed to certain environments, but is stable (i.e., does not degrade) when it is exposed to other environments. Thus, this selective nature gives the user significant control over the rate of degradation of the trigger mechanisms 1480 by selection of the trigger fluid environment 1430. Although the illustration in FIG. 14 shows two trigger mechanisms 1480, any number of trigger mechanisms 1480 can be used to customize the degradation profile and/or conditions of the substrate 1410 by increasing contact and surface exposure to the desired target environment 1430.

In some embodiments, the first trigger mechanism 1480A and the second trigger mechanism 1480B can have different electrical potentials and upon exposure to a target environment 1430, one of the trigger mechanisms 1480 will act as a sacrificial anode that will degrade first. Once the sacrificial anode has fully degraded to expose the substrate 1410 to the target environment 1430, then the substrate 1410 will act as the sacrificial anode relative to the other trigger mechanism 1480, thereby increasing the degradation rate of the substrate 1410. In some embodiments, as described above with respect to substrate 10, degradation of a sacrificial element can be configured to reduce the concentration of a chemical species available to degrade the substrate 1410.

### Experimental Examples

The following experiments were performed to demonstrate that aluminum (Al) readily degrades in the presence of hydrochloric acid (HCl) through a chemical reaction that forms aluminum chloride (AlCl₃). Al was used as a model degradable material to determine the efficacy of a barrier and various trigger mechanisms in tuning the degradation rate of the compound sample (Al with barrier and trigger). Six Al samples (approximately ½″×½″×½″ in size) were interrogated in 10 wt % HCl for one hour. Sample 1 was uncoated (i.e., possessing no barrier) and demonstrates the baseline degradation of Al in the absence of a protective barrier. The remaining five samples possessed a conformal coating and impregnating liquid, which acted as a barrier to delay the onset or decrease the rate of degradation. Sample 2 possessed the aforementioned barrier. Samples 3-5 had triggers in addition to the protective barrier to allow for the controlled failure of the barrier and facilitate faster degradation. The triggers consisted of ⅛″ diameter rods composed of a material that readily degraded in the presence of 10 wt % HCl. The trigger rods were coated with the protective barrier with the protruding end left uncoated such that the trigger degraded along the length of the rod. The length of the triggers could be increased to delay the degradation of the underlying Al substrate. The triggers for Samples 3 (one trigger) and 4 (two triggers) were inserted ⅕″ into the samples with 5/64″ protruding beyond the barrier of the Al sample. Sample 5 possessed one trigger which spanned the length of the sample and protruded 5/64″ beyond the barrier on both sides. Sample 6 had a ⅛″ hole drilled through the barrier and Al substrate to allow for degradation at the surface of the substrate exposed by the hole. A summary of the six samples is provided in Table 1.

TABLE 1
Summary of the distinguishing characteristics for the six Al samples
investigated. All six samples were composed of a ~½″ × ½″ × ½″
cube of Al conformally coated with a polymer and subsequently coated
with an impregnating liquid. A “trigger” was inserted ~⅕″ into
the samples unless otherwise noted. The magnesium (Mg) triggers
were subsequently cut and filed such that ~ 5/64″ was
protruding from the sample.

| Sample | Description |
|---|---|
| 1 | Uncoated Al, no trigger |
| 2 | Coated Al, no trigger |
| 3 | Coated Al, 1 trigger |
| 4 | Coated Al, 2 triggers |
| 5 | Coated Al, 1 trigger spanning length of sample |
| 6 | Coated Al, ⅛″ hole through sample |

The six samples were exposed to 10 wt % HCl for one hour to determine their degradation rates (given as mass lost from the sample). Table 2 summarizes the results of these experiments. Sample 1 showed significant mass loss and demonstrates the base degradation rate in the absence of a barrier. Sample 2 exhibited negligible mass loss as a result of the barrier protecting the Al substrate from degradation. The triggers employed in Samples 3-5 allowed for the localized failure of the barrier which delayed the onset of degradation (as the trigger itself degraded) and decreased the degradation rate due to a decrease in the area of exposed Al relative to Sample 1. The use of two trigger mechanisms with two individual triggers (Sample 4) or one trigger protruding from two locations in the barrier (Sample 5), enhanced the degradation beyond one trigger (cf. Sample 3 with Samples 4 and 5). The addition of another local failure point in the coating (i.e., a second trigger) provided additional exposed Al (after degradation of the fuse) and enhanced the degradation. Finally, if the fuse was removed from Sample 5 (or, more simply, a ⅛″ hole was drilled in the sample) the degradation rate could be further enhanced, because the fuse material did not necessarily have to degrade first.

TABLE 2
Summary of mass loss as a percent of the total mass (encompassing
the Al substrate, conformal coating, impregnating liquid, and
any inserted trigger(s)) for the six samples investigated.

| Sample | Mass Lost (%) |
|---|---|
| 1 | 81.43% |
| 2 | 0.80% |
| 3 | 9.89% |
| 4 | 23.84% |
| 5 | 22.34% |
| 6 | 32.12% |

These degradation experiments demonstrate that a barrier can be used to prevent the degradation of a model degradable material (e.g., Al) and that a barrier with intentional local defects can be used to retard the degradation rate of the base material. Additionally, the number and length of triggers can be varied to tune the rate of degradation of the sample, with additional and/or shorter triggers leading to an enhancement in the degradation rate.

1. A system, comprising:
a substrate including a degradable material, the degradable material configured to substantially degrade over a first time period; and
a barrier including at least one of a conformal coating and a liquid impregnated surface, the barrier configured to control a degradation profile of the degradable material such that the degradable material substantially degrades over a second time period.

2. The system of claim 1, wherein the barrier includes the conformal coating and the liquid impregnated surface.

3. The system of claim 1, wherein the second time period is greater than the first time period.

4. The system of claim 1, wherein the barrier includes two conformal coatings.

5. The system of claim 1, wherein the conformal coating substantially encapsulates the substrate.

6. The system of claim 1, wherein the conformal coating includes a plurality of coatings and a first portion of the coatings are homogeneous and a second portion of the coatings include a heterogeneous material.

7. The system of claim 1, wherein the conformal coating includes at least one of ceramic, plastic, metal, gold, chromium, aluminum, platinum, copper, nickel, gel, hydrogel, aerogel, a polar membrane composed of a lipid bilayer, carbon nanotube or graphene based membrane, polymer, fluorinated polymer, Polytetrafluoroethylene (PTFE), Polyvinylidene fluoride (PVDF), poly(p-xylylene) polymers, poly(perfluorodecylacrylate) (PFDA), polymethylmethacrylate (PMMA), polyglycidylmethacrylate (PGMA), poly-2-hydroxyethylmethacrylate, poly(perfluorononyl acrylate), poly(perfluorooctyl acrylate), poly(3,3,4,4,5,5,6,6,7,7,8,8,8-tridecafluorooctyl methacrylate), poly(1H,1H,2H,2H-perfluorooctyl acrylate), poly([N-methyl-perfluorohexane-1-sulfonamide]ethyl acrylate), poly([N-methyl-perfluorohexane-1-sulfonamide]ethyl(meth)acrylate), poly(2-(Perfluoro-3-methylbutyl)ethyl methacrylate)), poly(2-[[[[2-(perfluorohexyl)ethyl]sulfonyl]methyl]-amino]ethyl]acrylate), poly(2-[[[[2-(perfluoroheptyl)ethyl]sulfonyl]methyl]-amino]ethyl]acrylate), poly(2-[[[[2-(perfluorooctyl)ethyl]sulfonyl]methyl]-amino]ethyl]acrylate), ethylene dimethyacrylate (EDMA), di(ethyleneglycol)di(methacrylate), di(ethyleneglycol)di(acrylate), ethyleneglycoldimethyacrylate (EGDMA), parylene-N, parylene-C, parylene-D, parylene-HT, di(ethyleneglycol)di(vinylether) (EDGDVE), 1H,1H,6H,6H-perfluorohexyldiacrylate, diethyleneglycol divinyl ether, divinyl benzene (DVB), diamond-like carbon, SiO₂, SiN, TiO₂, TiN, SiC, cyclic siloxanes, 1,3,5-trivinyl-1,3,5-trimethylcyclotrisiloxane (V3D3), and zwitterionic polymers.

8. The system of claim 1, wherein the liquid impregnated surface includes a matrix of solid features.

9. The system of claim 8, wherein the matrix of solid features is created via polishing, sandblasting, rubbing with sandpaper, dry ice blasting, milling, drilling, filing, cutting, high pressure cutting/machining, a water-jet, laser cutting, laser rastering, dry etching, plasma etching, reactive ion etching, deep reactive ion etching, sputter etching, ion milling, vapor phase etching, corona etching, heat treatment, flame treatment, plasma treatment, irradiation, wet etching, exposure to acid or base solutions, exposure to ionic liquids, boiling in solvents, anodization, electrodissolution, stamping, embossing, casting, sintering, powder sintering.

10. The system of claim 8, wherein the matrix of solid features includes a plurality of particles comprising at least one of insoluble fibers, purified wood cellulose, micro-crystalline cellulose, oat bran fiber, wax, carnauba wax, Japan wax, beeswax, rice bran wax, candelilla wax, fluorinated waxes, waxes containing silicon, waxes of esters of fatty acids, fatty acids, fatty acid alcohols, glycerides, polysaccharides, fructo-oligosaccharides, metal oxides, montan wax, lignite, peat, ozokerite, ceresins, bitumens, petrolatuns, paraffins, microcrystalline wax, lanolin, esters of metal and alkali, flour of coconut, almond, potato, wheat, pulp, zein, dextrin, cellulose ethers, Hydroxyethyl cellulose, Hydroxypropyl cellulose (HPC), Hydroxyethyl methyl cellulose, Hydroxypropyl methyl cellulose (HPMC), Ethyl hydroxyethyl cellulose, ferric oxide, ferrous oxide, silicas, clay minerals, bentonite, palygorskite, kaolinite, vermiculite, apatite, graphite, molybdenum disulfide, mica, boron nitride, sodium formate, sodium oleate, sodium palmitate, sodium sulfate, sodium alginate, agar, gelatin, pectin, gluten, starch alginate, carrageenan, whey and edible solid particles.

11. The system of claim 8, wherein the matrix of solid features includes at least one of polymeric materials, polymers, fluorinated polymers, fluorinated waxes, perfluorinated polymers, plastic, glass, metal, ceramics, polystyrene, nylon, polypropylene, wax, polyethylene terephthalate, polypropylene, polyethylene, polyurethane, polysulphone, polyethersulfone, polytetrafluoroethylene (PTFE), tetrafluoroethylene (TFE), fluorinated ethylenepropylene copolymer (FEP), polyvinylidene fluoride (PVDF), perfluoroalkoxytetrafluoroethylene copolymer (PFA), perfluoromethyl vinylether copolymer (MFA), ethylenechlorotrifluoroethylene copolymer (ECTFE), ethylene-tetrafluoroethylene copolymer (ETFE), polychlorotetrafluoroethylene (PCTFE), polyvinyl alcohol (PVA), polyethyleneglycol (PEG), polyfluoropolyether (PFPE), poly(acrylic acid), and poly(propylene oxide).

12. The system of claim 1, further comprising:
a trigger mechanism configured to modify the degradation profile of the degradable material.

13. A system, comprising:
a substrate including a degradable material;
a barrier including at least one of a conformal coating and a liquid impregnated surface, the barrier configured to control a degradation profile of the degradable material; and
a trigger mechanism configured to initiate degradation of the degradable material.

14. The system of claim 13, wherein the trigger mechanism is configured to modify the degradation profile of the degradable material.

15. The system of claim 13, wherein the trigger mechanism is configured to accelerate degradation of the degradable material.

16. The system of claim 13, wherein the trigger mechanism includes a degradable fuse material at least partially disposed inside a substrate, the degradable fuse material formulated to dissolve at a first degradation rate when exposed to a first environment, and at a second degradation rate when exposed to a second environment.

17. The system of claim 16, wherein the second environment includes a trigger fluid formulated to transition dissolution of the degradable fuse material from the first degradation rate to the second degradation rate.

18. The system of claim 13, wherein the trigger mechanism is disposed through the substrate.

19. The system of claim 13, wherein the trigger mechanism is disposed in multiple locations on the substrate.

20. The system of claim 13, wherein the trigger mechanism includes a dissolvable layer.

21. A system, comprising:
a substrate including a degradable material, the degradable material configured to substantially degrade over a first time period;
a barrier including at least one of a conformal coating and a liquid impregnated surface, the barrier configured to control a degradation profile of the degradable material such that the degradable material substantially degrades over a second time period; and
a trigger mechanism configured to modify the degradation profile of the degradable material.

22. The system of claim 21, wherein the trigger mechanism includes a material that degrades, decomposes, or melts in a brine solution.

23. The system of claim 21, wherein the trigger mechanism includes a material that degrades, decomposes, or melts in an acidic solution.

24. The system of claim 23, wherein the acidic solution includes at least one of hydrochloric acid, sulfuric acid, hydrofluoric acid, and phosphoric acid.

25. The system of claim 21, wherein the trigger mechanism includes a material that degrades, decomposes, or melts in a caustic solution.

26. The system of claim 25, wherein the caustic solution includes at least one of sodium hydroxide and potassium hydroxide.

27. The system of claim 21, wherein the trigger mechanism includes a material that degrades, decomposes, or melts in a chemical solvent.

28. The system of claim 27, wherein the chemical solvent includes at least one of acetone, isopropanol, benzene, toluene, methanol, ethanol, xylene, and tetrahydrofuran.

29. The system of claim 21, wherein the trigger mechanism includes a metal or alloy comprising at least one of magnesium, aluminum, calcium, germanium, zinc, and manganese.

30. The system of claim 21, wherein the trigger mechanism includes at least one of an organic material, a water-soluble material, polyesters, polylactic acid, polyglycolic acid, polyhydroxy butyrates, polyvinyl acetates, polyvinyl alcohols, polyacrylic acids, polyethylene glycol polysaccharides, polyvinyl chlorides, acrylonitrile butadiene styrene (ABS), and polystyrenes.
